(19) United States
(12) Patent Application Publication
(10) Pub. No.: US 2024/0372098 A1
(43) Pub. Date: Nov. 7, 2024

(54) ELECTRODE BINDERS COMPRISING A BLEND OF A POLYBUTADIENE-BASED POLYMER AND A POLYNORBORNENE-BASED POLYMER, ELECTRODES COMPRISING SAME AND USE THEREOF IN ELECTROCHEMISTRY

(71) Applicant: HYDRO-QUÉBEC, Montréal (CA)

(72) Inventors: Benoit FLEUTOT, Boucherville (CA); Emmanuelle GARITTE, Montréal (CA); Jean-Christophe DAIGLE, St-Bruno-de-Montarville (CA); Marie-Claude GIRARD, Sainte-Julie (CA); Amélie FORAND, Boucherville (CA)

(21) Appl. No.: 18/566,233

(22) PCT Filed: Jun. 3, 2022
(86) PCT No.: PCT/CA2022/050890

§ 371 Date: Dec. 1, 2023

(30) Foreign Application Priority Data
Jun. 3, 2021 (CA) 3120992

(51) Int. Cl. H01M 4/62; H01M 4/02; H01M 10/0562

(52) U.S. Cl. CPC H01M 4/622; H01M 4/625; H01M 10/0562; H01M 2004/027; H01M 2004/028; H01M 2300/0068

(57) ABSTRACT

The present technology relates to binder compositions and binders comprising a blend comprising a polybutadiene-based polymer and a polynorbornene-based polymer comprising norbornene-based monomer units derived from the polymerization of an optionally substituted norbornene-based monomer for use in electrochemical applications, particularly in electrochemical accumulators such as all-solid-state batteries. Also described are electrode materials comprising said binder or binder composition and their use in electrochemical cells, for example, in electrochemical accumulators, particularly in all-solid-state batteries.

### RELATED APPLICATION

This application claims priority, under applicable law, to Canadian provisional patent application No. 3,120,992 filed on Jun. 3, 2021, the content of which is incorporated herein by reference in its entirety and for all purposes.

### TECHNICAL FIELD

The present application relates to the field of polymers and their use in electrochemical applications. More particularly, the present application relates to the field of polymer binders, electrode materials comprising them, their manufacturing processes, and their use in electrochemical cells, particularly in all-solid-state batteries.

### BACKGROUND

The development of solid electrolytes based on polymers and/or ceramics has made it possible to design all-solid-state electrochemical systems that are substantially safer, lighter, more flexible, and more efficient than their counterparts based on the use of liquid electrolytes.

An ideal all-solid-state electrochemical system would consist of a negative electrode, a solid electrolyte, and a composite positive electrode composed of an electrochemically active material, the solid electrolyte, and optionally an electronically conductive material. All of which could form a monolithic unit.

One of the key elements of an all-solid-state electrochemical system is the dispersion of each of its components. Indeed, the solid elements can tend to agglomerate during the mixing step with the binder, rendering the electrode material inhomogeneous. Among the strategies employed to solve this problem, we find the encapsulation of the particles of the different components of the system with coating materials to improve their dispersion. These dispersion problems can also be significantly reduced through the use of binders, additives, or dispersion media that improve particle dispersion.

Polymers based on norbornene have been described as additives in the PCT patent application published under number WO2020/061710 (Daigle et al.), these being added to a polymer binder. Polynorbornenes are added, for example, to suppress or reduce parasitic reactions such as the formation of lithium fluoride (LiF) and hydrofluoric acid (HF) resulting from the degradation of carbon-fluorine (C—F) bonds.

The Korean patent published under number KR 10-2193945 and the PCT patent application published under number WO2019/004714 describe a process for manufacturing a solid electrolyte film comprising a sulfide-based solid electrolyte and a composite electrode film allowing to improve the dispersion, density, and ionic conductivity properties between the solid electrolyte particles and between the solid electrolyte particles and the active material particles by crystallization from an amorphous to a crystalline state. To do this, a norbornene-based copolymer is used, in particular poly(ethylene-co-propylene-co-5-methylene-2-norbornene (PEPMNB).

Nevertheless, there is still a need for the development of new materials for use in all-solid-state electrochemical systems having improved properties.

### SUMMARY

According to an aspect, the present technology relates to a binder composition comprising a blend comprising a polybutadiene-based polymer and a polynorbornene-based polymer comprising norbornene-based monomer units derived from polymerization of a compound of Formula I:

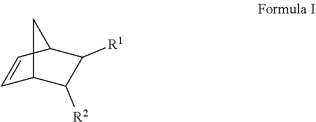

wherein,
R¹ and R² are independently and in each occurrence selected from a hydrogen atom, a carboxyl group (—COOH), a sulfonic acid group (—SO₃H), a hydroxyl group (—OH), a fluorine atom, and a chlorine atom.

In an embodiment, the polynorbornene-based polymer is a polymer of Formula II:

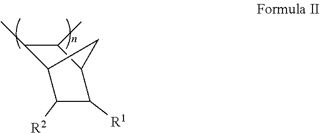

wherein,
R¹ and R² are as defined herein; and
n is an integer selected so that the mass average molecular weight of the polymer of Formula II is between about 10,000 g/mol and about 100 000 g/mol, upper and lower limits included.

In another embodiment, the mass average molecular weight of the polymer of Formula II is between about 12,000 g/mol and about 85,000 g/mol, or between about 15,000 g/mol and about 75,000 g/mol, or between about 20,000 g/mol and about 65,000 g/mol, or between about 25,000 g/mol and about 55,000 g/mol, or between about 25,000 g/mol and about 50,000 g/mol, upper and lower limits included.

In another embodiment, R¹ and R² are independently and in each occurrence selected from a hydrogen atom and a —COOH group. According to an example, R¹ is a —COOH group and R² is a hydrogen atom. According to another example, R¹ and R² are both —COOH groups.

In another embodiment, the polybutadiene-based polymer is polybutadiene.

In another embodiment, the polybutadiene-based polymer is selected from epoxidized polybutadienes. According to an example, the epoxidized polybutadiene comprises repeating units of Formulae III, IV, and V:

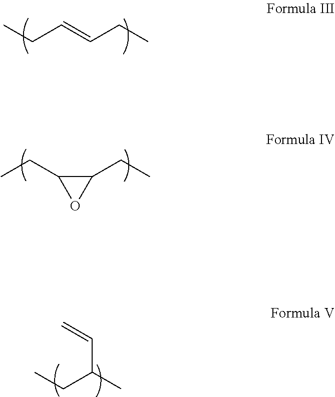

and two hydroxyl end groups.

According to another example, the epoxidized polybutadiene is of Formula VI:

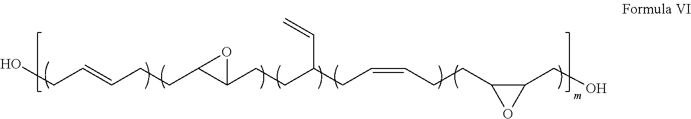

wherein,
m is an integer selected so that the mass average molecular weight of the epoxidized polybutadiene of Formula VI is between about 1,000 g/mol and about 1,500 g/mol, upper and lower limits included; and
the epoxide equivalent weight is between about 100 g/mol and about 600 g/mol, upper and lower limits included.

According to another example, the epoxidized polybutadiene is a Poly bd™ 600E resin with a mass average molecular weight of about 1,300 g/mol and an epoxide equivalent weight of between about 400 g/mol and about 500 g/mol, upper and lower limits included.

According to another example, the epoxidized polybutadiene is a Poly bd™ 605E resin with a mass average molecular weight of about 1,300 g/mol and an epoxide equivalent weight of between about 260 g/mol and about 330 g/mol, upper and lower limits included.

In another embodiment, the weight ratio of polybutadiene-based polymer: polynorbornene-based polymer is in the range of from about 6:1 to about 2:3, upper and lower limits included. For example, the weight ratio is in the range of from about 5.5:1 to about 2:3, or from about 5:1 to about 2:3, or from about 4.5:1 to about 2:3, or from about 4:1 to about 2:3, or from about 6:1 to about 1:1, or from about 5.5:1 to about 1:1, or from about 5:1 to about 1:1, or from about 4.5:1 to about 1:1, or from about 4:1 to about 1:1, upper and lower limits included. According to a variant of interest, the weight ratio is in the range of from about 4:1 to about 1:1, upper and lower limits included.

According to another aspect, the present technology relates to a binder comprising a binder composition as defined herein. According to an example, the binder is used in an electrode material.

According to another aspect, the present technology relates to an electrode material comprising an electrochemically active material and a binder as defined herein.

In an embodiment, the electrochemically active material is selected from a metal oxide, a metal sulfide, a metal oxysulfide, a metal phosphate, a metal fluorophosphate, a metal oxyfluorophosphate, a metal sulfate, a metal halide, a metal fluoride, sulfur, selenium, and a combination of at least two thereof. For example, the metal of the electrochemically active material is selected from titanium (Ti), iron (Fe), manganese (Mn), vanadium (V), nickel (Ni), cobalt (Co), aluminum (Al), chromium (Cr), copper (Cu), zirconium (Zr), niobium (Nb), and a combination of at least two thereof. According to an example, the electrochemically active material further comprises an alkali or alkaline earth metal selected from lithium (U), sodium (Na), potassium (K), and magnesium (Mg).

In an embodiment, the electrochemically active material is selected from a non-alkali or non-alkaline-earth metal, an intermetallic compound, a metal oxide, a metal nitride, a metal phosphide, a metal phosphate, a metal halide, a metal fluoride, a metal sulfide, a metal oxysulfide, carbon, silicon (Si), a silicon-carbon composite (Si—C), a silicon oxide (SiO), a silicon oxide-carbon composite (SiCₓ—C), tin (Sn), a tin-carbon composite (Sn—C), a tin oxide (SnOₓ), a tin oxide-carbon composite (SnOₓ—C), and a combination of at least two thereof.

In another embodiment, the electrochemically active material further comprises a doping element.

In another embodiment, the electrochemically active material is in the form of particles. For example, the electrochemically active material particles additionally comprise a coating material. According to an example, the coating material is selected from Li₂SiO₃, Li₄Ti₅O₁₂, LiTaO₃, LiAlO₂, Li₂O—ZrO₂, LiNbO₃, other similar materials, and a combination of at least two thereof. According to another example, the coating material is an electronically conductive material.

In another embodiment, the electrode material further comprises an electronically conductive material. For example, the electronically conductive material is selected from the group consisting of carbon black, acetylene black, graphite, graphene, carbon fibers, carbon nanofibers, carbon nanotubes, and a combination of at least two thereof. According to an example of interest, the surface of said electronically conductive material is grafted with at least one aryl group of Formula VII:

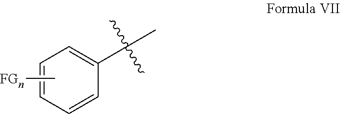

wherein,
FG is a hydrophilic functional group; and n is an integer in the range of from 1 to 5, preferably n is in the range of from 1 to 3, preferably n is 1 or 2, or more preferably n is 1.

According to an example, the hydrophilic functional group is a carboxylic acid or sulfonic acid functional group. According to another example, the aryl group of Formula VII is p-benzoic acid or p-benzenesulfonic acid.

In another embodiment, the electrode material further comprises an additive. For example, the additive is selected from ionic conductive materials, inorganic particles, glass or glass-ceramic particles, ceramic particles, nano-ceramics, salts, and a combination of at least two thereof. According to an example, the additive comprises ceramic, glass, or glass-ceramic particles based on fluoride, phosphide, sulfide, oxysulfide, or oxide. According to another example, the additive is selected from LISICON, thio-LISICON, argyrodite, garnet, NASICON, perovskite type compounds, oxides, sulfides, oxysulfides, phosphides, fluorides, in crystalline and/or amorphous form, and a combination of at least two thereof. According to another example, the additive is selected from inorganic compounds of the formulae MLZO (for example, M₇La₃Zr₂O₁₂, M₍₇₋ₐ₎La₃Zr₂AlbO₁₂, M₍₇₋ₐ₎La₃Zr₂GabO₁₂, M₇₋ₐ)La₃Zr_{(2-b)}Ta_{b}O₁₂, and M₍₇₋ₐ₎La₃Zr_{(2-b)}Nb_{b}O₁₂); MLTaO (for example, M₇La₃Ta₂O₁₂, M₅La₃Ta₂O₁₂, and M₆La₃Ta_{1.5}Y_{0.5}O₁₂); MLSnO (for example, M₇La₃Sn₂O₁₂); MAGP (for example, M₁₊ₐAlₐGe₂₋ₐ(PO₄)₃); MATP (for example, M₁₊ₐAlₐTi₂₋ₐ(PO₄)₃); MLTiO (for example, M₃ₐLa_{(2/3-a)}TiO₃); MZP (for example, MₐZr_{b}(PO₄)_{c}); MCZP (for example, MₐCa_{b}Zr_{c}(PO₄)_{d}); MGPS (for example, MₐGe_{b}P_{c}S_{d} such as M₁₀GeP₂S₁₂); MGPSO (for example, MₐGe_{b}P_{c}S_{d}Oₑ); MSiPS (for example, MₐSi_{b}P_{c}S_{d} such as M₁₀SiP₂S₁₂); MSIPSO (for example, MₐSi_{b}P_{c}S_{d}Oₑ); MSnPS (for example, MₐSn_{b}P_{c}S_{d} such as M₁₀SnP₂S₁₂); MSnPSO (for example, MₐSn_{b}P_{c}S_{d}Oₑ); MPS (for example, MₐPbS_{c} such as M₇P₃S₁₁); MPSO (for example, MₐPbS_{c}O_{d}); MZPS (for example, MₐZn_{b}P_{c}S_{d}); MZPSO (for example, MₐZn_{b}P_{c}S_{d}Oₑ); XM₂S-yP₂S₅; XM₂S-yP₂S₅-zMX; XM₂S-yP₂S₅-zP₂O₅; XM₂S-yP₂S₅-zP₂O₅-wMX; xM₂S-yM₂O-zP₂S₅; xM₂S-yM₂O-zP₂S₅-wMX; xM₂S-yM₂O-zP₂S₅-wP₂O₅; xM₂S-yM₂O-zP₂S₅-wP₂O₅-vMX; xM₂S-ySiS₂; MPSX (for example, MₐPbSJ(_{d} such as M₇P₃S₁₁X, M₇P₂S_{B}X, and M₆PS₅X); MPSOX (for example, MₐP_{b}S_{c}O_{d}Xₑ); MGPSX (for example, MₐGe_{b}P_{c}S_{d}Xₑ); MGPSOX (for example, MₐGe_{b}P_{c}S_{d}OₑX_{f}); MSiPSX (for example, MₐSi_{b}P_{c}S_{d}Xₑ); MSIPSOX (for example, MₐSi_{b}P_{c}S_{d}OₑX_{f}); MSnPSX (for example, MₐSn_{b}P_{c}S_{d}Xₑ); MSnPSOX (for example, MₐSn_{b}P_{c}S_{d}OₑX_{f}); MZPSX (for example, M₂Zn_{b}P_{c}S_{d}Xₑ); MZPSOX (for example, MₐZn_{b}P_{c}S_{d}OₑX_{f}); M₃OX; M₂HOX; M₃PO₄; M₃PS₄; and MₐPO_{b}N_{c} (where a=2b+3c−5);

wherein:
M is an alkali metal ion, an alkaline earth metal ion, or a combination thereof, and wherein when M comprises an alkaline earth metal ion, then the number of M is adjusted to achieve electroneutrality;
X is selected from F, Cl, Br, I, or a combination of at least two thereof;
a, b, c, d, e, and f are numbers other than zero and are, independently in each formula, selected to achieve electroneutrality; and
v, w, x, y, and z are numbers other than zero and are, independently in each formula, selected to obtain a stable compound.

According to a variant of interest, the additive is selected from inorganic argyrodite-type compounds of formula Li₆PS₅X, wherein X is Cl, Br, I, or a combination of at least two thereof. For example, the additive is Li₆PS₅Cl.

According to another aspect, the present technology relates to an electrode comprising the electrode material as defined herein on a current collector. According to another aspect, the present technology relates to a self-supported electrode comprising the electrode material as defined herein.

According to another aspect, the present technology relates to an electrochemical cell comprising a negative electrode, a positive electrode, and an electrolyte, wherein at least one of the positive electrode or the negative electrode is as defined herein or comprises an electrode material as defined herein.

In another embodiment, the electrolyte is a liquid electrolyte comprising a salt in a solvent.

In another embodiment, the electrolyte is a gel electrolyte comprising a salt in a solvent and optionally a solvating polymer.

In another embodiment, the electrolyte is a solid polymer electrolyte comprising a salt in a solvating polymer.

In another embodiment, the electrolyte is a polymer-ceramic hybrid solid electrolyte.

In another embodiment, the electrolyte comprises an inorganic solid electrolyte material.

According to an example, the inorganic solid electrolyte material comprises ceramic, glass, or glass-ceramic particles based on fluoride, phosphide, sulfide, oxysulfide, or oxide. According to another example, the inorganic solid electrolyte material is selected from LISICON, thio-LISICON, argyrodite, garnet, NASICON, perovskite type compounds, oxides, sulfides, oxysulfides, phosphides, fluorides, in crystalline and/or amorphous form, and a combination of at least two thereof. According to another example, the inorganic solid electrolyte material is selected from inorganic compounds of the formulae MLZO (for example, M₇La₃Zr₂O₁₂, M₍₇₋ₐ₎La₃Zr₂AlbO₁₂, M₍₇₋ₐ₎La₃Zr₂GabO₁₂, M₍₇₋ₐ₎La₃Zr_{(2-b)}Ta_{b}O₁₂, and M(₇₋ₐ)La₃Zr)Nb_{b}O₁₂); MLTaO (for example, M₇La₃Ta₂O₁₂, M₅La₃Ta₂O₁₂, and M₆La₃Ta_{1.5}Y_{0.5}O₁₂); MLSnO (for example, M₇La₃Sn₂O₁₂); MAGP (for example, M₁₊ₐAlₐGe₂₋ₐ(PO₄)₃); MATP (for example, M₁₊ₐAlₐTi₂₋ₐ(PO₄)₃); MLTiO (for example, M₃ₐLa_{(2/3-a)}TiO₃); MZP (for example, MₐZr_{b}(PO₄)ᵣ); MCZP (for example, MₐCa_{b}Zr_{c}(PO₄)_{d}); MGPS (for example, MₐGe_{b}P_{c}S_{d} such as M₁₀GeP₂Si₂); MGPSO (for example, MₐGe_{b}P_{c}S_{d}Oₑ); MSiPS (for example, MₐSi_{b}P_{c}S_{d} such as M₁₀SiP₂S₁₂); MSIPSO (for example, MₐSi_{b}P_{c}S_{d}Oₑ); MSnPS (for example, MₐSn_{b}P_{c}S_{d} such as M₁₀SnP₂S₁₂); MSnPSO (for example, MₐSn_{b}P_{c}S_{d}Oₑ); MPS (for example, MₐPbS_{c} such as M₇P₃S); MPSO (for example, MₐP_{b}S_{c}O_{d}); MZPS (for example, MₐZn_{b}P_{c}S_{d}); MZPSO (for example, MₐZn_{b}P_{c}S_{d}Oₑ); xM₂S-yP₂S₅; xM₂S-yP₂S₅-zMX; xM₂S-yP₂S₅-zP₂O₅; xM₂S-yP₂S₅-zP₂O₅-wMX; xM₂S-yM₂O-zP₂S₅; xM₂S-yM₂O-zP₂S₅-wMX; xM₂S-yM₂O-zP₂S₅-wP₂O₅; xM₂S-yM₂O-zP₂S₅-wP₂O₅-vMX; xM₂S-ySiS₂; MPSX (for example, MₐP_{b}S_{c}X_{d} such as M₇P₃S₁₁X, M₇P₂SaX, and M₆PS₅X); MPSOX (for example, MₐP_{b}S_{c}O_{d}Xₑ); MGPSX (for example, MₐGe_{b}P_{c}S_{d}Xₑ); MGPSOX (for example, MₐGe_{b}P_{c}S_{d}OₑX_{f}); MSiPSX (for example, MₐSi_{b}P_{c}S_{d}Xₑ); MSIPSOX (for example, MₐSi_{b}P_{c}S_{d}OₑX_{f}); MSnPSX (for example, MₐSn_{b}P_{c}S_{d})(ₑ); MSnPSOX (for example, MₐSn_{b}P_{c}S_{d}OₑX_{f}); MZPSX (for example, MₒZn_{b}P X_{c}); MZPSOX (for example, M₂Zn_{b}P_{c}S_{d}OₑX_{f}); M₃OX; M₂HOX; M₃PO₄; M₃PS₄; and MₐPO_{b}N_{c} (where a=2b+3c−5); wherein:
M is an alkali metal ion, an alkaline earth metal ion, or a combination thereof, and wherein when M comprises an alkaline earth metal ion, then the number of M is adjusted to achieve electroneutrality;
X is selected from F, Cl, Br, I, or a combination of at least two thereof;
a, b, c, d, e, and f are numbers other than zero and are, independently in each formula, selected to achieve electroneutrality; and
v, w, x, y, and z are numbers other than zero and are, independently in each formula, selected to obtain a stable compound.

According to a variant of interest, the inorganic solid electrolyte material is selected from argyrodite-type inorganic compounds of formula Li₆PS₅X, wherein X is Cl, Br, I, or a combination of at least two thereof. For example, the inorganic solid electrolyte material is Li₆PS₅Cl.

According to another aspect, the present technology relates to an electrochemical accumulator comprising at least one electrochemical cell as defined herein.

In another embodiment, the electrochemical accumulator is a battery selected from a lithium battery, a lithium-ion battery, a sodium battery, a sodium-ion battery, a magnesium battery, and a magnesium-ion battery.

In another embodiment, the electrochemical accumulator is an all-solid-state battery.

### BRIEF DESCRIPTION OF THE FIGURES

FIG. 1 shows in (A) an SEM image of Film 1, and in (B) the corresponding EDS mapping image allowing the analysis of the distribution of elements Ni and S, as described in Example 4. The scale bars represent 300 μm and 100 μm, respectively.

FIG. 2 shows in (A) an SEM image of Film 2, and in (B) the corresponding EDS mapping image allowing the analysis of the distribution of elements Ni and S, as described in Example 4. The scale bars represent 100 μm.

FIG. 3 shows in (A) an SEM image of Film 3, and in (B) the corresponding EDS mapping image allowing the analysis of the distribution of elements Ni and S, as described in Example 4. The scale bars represent 100 μm.

FIG. 4 shows in (A) an SEM image of Film 4, and in (B) the corresponding EDS mapping image allowing the analysis of the distribution of elements Ni and S, as described in Example 4. The scale bars represent 100 μm.

FIG. 5 shows in (A) an SEM image of Film 5, and in (B) the corresponding EDS mapping image allowing the analysis of the distribution of elements Ni and S, as described in Example 4. The scale bars represent 100 μm.

FIG. 6 shows in (A) an SEM image of Film 7 allowing the different layers of the film to be observed, and in (B) a top-view SEM image of the same film, as described in Example 4. The scale bars represent 100 μm.

FIG. 7 shows in (A) an SEM image of Film 8 allowing the different layers of the film to be observed, and in (B) a top-view SEM image of the same film, as described in Example 4. The scale bars represent 100 μm.

FIG. 8 shows in (A) an SEM image of Film 9 allowing the different layers of the film to be observed, and in (B) a top-view SEM image of the same film, as described in Example 4. The scale bars represent 100 μm.

FIG. 9 shows a graph of the discharge capacity (mAh/g) and the coulombic efficiency (%) as a function of the number of cycles for Cell 1 (▪) and Cell 2 (▴), as described in Example 5(b).

FIG. 10 shows a graph of the average charge and discharge potential (V) as a function of the number of cycles for Cell 1 (▪) and Cell 2 (▴), as described in Example 5(b).

FIG. 11 shows a graph of the discharge capacity (mAh/g) and the coulombic efficiency (%) as a function of the number of cycles for Cell 3 (▪), Cell 4 (●), and Cell 5 (▴), as described in Example 5(b).

FIG. 12 shows a graph of the average charge and discharge potential (V) as a function of the number of cycles for Cell 3 (▪), Cell 4 (●), and Cell 5 (▴), as described in Example 5(b).

FIG. 13 shows a graph of the discharge capacity and the coulombic efficiency (%) as a function of the number of cycles for Cell 6 (▪), Cell 7 (▴), Cell 8 (●), Cell 9 (▾), and Cell 10 (★), as described in Example 5(b).

FIG. 14 shows a graph of the average charge and discharge potential (V) as a function of the number of cycles for Cell 6 (▪), Cell 7 (▴), Cell 8 (●), Cell 9(▾), and Cell 10 (★), as described in Example 5(b).

### DETAILED DESCRIPTION

All technical and scientific terms and expressions used herein have the same definitions as those generally understood by the person skilled in the art of the present technology. The definition of some terms and expressions used is nevertheless provided below.

When the term “about” is used herein, it means approximately, in the region of, or around. For example, when the term “about” is used in relation to a numerical value, it modifies it above and below by a variation of 10% from its nominal value. This term may also take into account, for example, the experimental error of a measuring device or rounding.

When a range of values is mentioned in the present application, the lower and upper limits of the range are, unless otherwise indicated, always included in the definition. When a range of values is mentioned in the present application, then all intermediate ranges and sub-ranges, as well as the individual values included in the ranges of values, are included in the definition.

When the article “a” is used to introduce an element in the present application, it does not have the meaning of “one only”, but rather of “one or more”. Of course, where the description states that a particular step, component, element, or feature “may” or “could” be included, that particular step, component, element, or feature is not required to be included in each embodiment.

For greater clarity, the expression “monomer units derived from” and equivalent expressions, as used herein, refer to repeating polymer units obtained from the polymerization of a polymerizable monomer.

The term “aryl” as used herein refers to substituted or unsubstituted aromatic rings, the contributing atoms being able to form one ring or a plurality of fused rings. Representative aryl groups include groups having 6 to 14 ring members. For example, aryl may comprise phenyl, naphthyl, etc. The aromatic ring may be substituted at one or more ring positions with, for example, a carboxyl (—COOH) or sulfonic acid (—SO₃H) group, an amine group, and other similar groups.

The expression “hydrophilic functional group” as used herein refers to functional groups that are attracted to water molecules. Hydrophilic functional groups may generally be charged and/or capable of forming hydrogen bonds. Non-limiting examples of hydrophilic functional groups comprise hydroxyl, carboxyl, sulfonic acid, phosphonic acid, amine, amide, and other similar groups. The expression further encompasses salts of these groups when applicable.

The expression “self-supported electrode” as used herein refers to an electrode without a metal current collector.

The chemical structures described herein are drawn according to the conventions of the field. Also, when an atom, such as a carbon atom, as drawn appears to include an incomplete valence, then the valence is assumed to be satisfied by one or more hydrogen atoms even if they are not explicitly drawn.

The present technology relates to an electrode binder comprising a blend of polymers, more specifically an electrode binder comprising a blend of polymers for use in all-solid-state electrochemical systems.

More particularly, the present technology relates to an electrode binder comprising a blend including a polybutadiene-based polymer and a polynorbornene-based polymer comprising norbornene-based monomer units derived from the polymerization of a compound of Formula I:

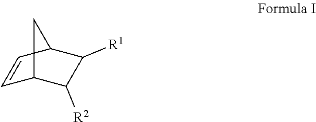

wherein,
R¹ and R² are independently and in each occurrence selected from a hydrogen atom, a carboxyl group (—COOH), a sulfonic acid group (—SO₃H), a hydroxyl group (—OH), a fluorine atom, and a chlorine atom.

According to an example, at least one of R¹ or R² is selected from —COOH, —SO₃H, —OH, —F, and —Cl, which means that at least one of R¹ or R² is different from a hydrogen atom.

According to another example, R¹ is a —COOH group and R² is a hydrogen atom.

According to another example, at least one of R¹ or R² is a —COOH group and the norbornene-based monomer units are carboxylic acid-functionalized norbornene-based monomer units. According to a variant of interest, R¹ is a —COOH group and R² is a hydrogen atom. According to another variant of interest, R¹ and R² are both —COOH groups.

The present technology also relates to an electrode binder comprising a blend including a polybutadiene-based polymer and a polynorbornene-based polymer of Formula II:

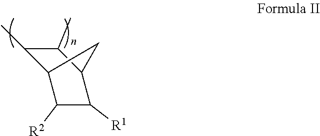

wherein,
R¹ and R² are as defined above, and n is an integer selected so that the mass average molecular weight of the polymer of Formula II is between about 10,000 g/mol and about 100 000 g/mol as determined by gel permeation chromatography (GPC), upper and lower limits included.

According to another example, the mass average molecular weight of the polynorbornene-based polymer of Formula II is between about 12,000 g/mol and about 85,000 g/mol, or between about 15,000 g/mol and about 75,000 g/mol, or between about 20,000 g/mol and about 65,000 g/mol, or between about 25,000 g/mol and about 55,000 g/mol, or between about 25,000 g/mol and about 50,000 g/mol as determined by GPC, upper and lower limits According to a variant of interest. R¹ and R² are —COOH groups.

According to another example, the polynorbornene-based polymer is of Formula II(a):

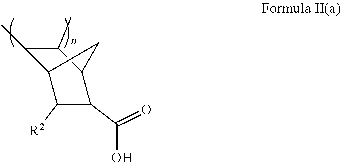

wherein,
R² and n are as defined above.

According to another example, the polynorbornene-based polymer is of Formula II(b):

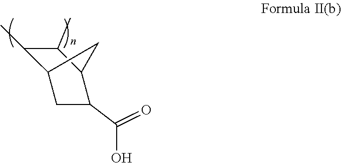

wherein,
n is as defined above.

According to another example, the polynorbornene-based polymer of Formulae II, II(a), or II(b) is a homopolymer.

According to another example, the polymerization of a norbornene-based monomer of Formula I may be carried out by any known compatible polymerization method. According to a variant of interest, the polymerization of the compound of Formula I may be carried out by the synthesis process as described by Commarieu, B. et al. (Commarieu, Basile, et al. “Ultrahigh T_{g} Epoxy Thermosets Based on Insertion Polynorbornenes”, Macromolecules, 49.3 (2016): 920-925). For example, the polymerization of the compound of Formula I may also be carried out by an addition polymerization process.

For example, polynorbornene-based polymers produced by an addition polymerization process can be substantially stable under severe conditions (for example, acidic and basic conditions). The addition polymerization of polynorbornene-based polymers may be carried out using inexpensive norbornene-based monomers. The glass transition temperature (Tₒ) obtained with polynorbornene-based polymers produced by this polymerization route may be equal to or higher than about 300° C., for example, as high as 350° C.

According to another example, the polybutadiene-based polymer may be characterized by substantially higher elasticity or flexibility and/or substantially lower glass transition temperature (Tₒ) than those of the polynorbornene-based polymer of Formulae II, II(a) or II(b).

According to another example, the polybutadiene-based polymer may be polybutadiene. Alternatively, the polybutadiene-based polymer may be functionalized polybutadiene or a polybutadiene-derived polymer. For example, in comparison with non-functionalized polybutadiene, the functionalized polybutadiene or polybutadiene-derived polymer may be characterized by substantially higher elasticity or flexibility, and/or substantially lower glass transition temperature (Tₒ) and/or may improve the mechanical or cohesive properties of the electrode binder.

According to another example, the polybutadiene-based polymer is selected from epoxidized polybutadienes, for example, epoxidized polybutadienes having reactive end groups. For example, the reactive end groups may be hydroxyl groups. The epoxidized polybutadiene may comprise repeating units of Formulae III, IV, and V:

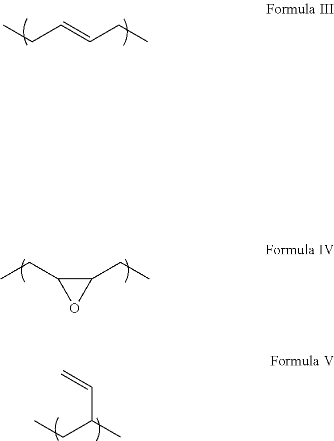

and two hydroxyl end groups.

According to another example, the mass average molecular weight of the epoxidized polybutadiene comprising repeating units of Formulae III, IV, and V may be between about 1,000 g/mol and about 1,500 g/mol as determined by GPC, upper and lower limits included.

According to another example, the epoxide equivalent weight of the epoxidized polybutadiene comprising repeating units of Formulae III, IV, and V is between about 100 g/mol and about 600 g/mol as determined by GPC, upper and lower limits included. The epoxide equivalent weight corresponds to the mass of resin containing 1 mol of epoxide functional groups.

According to a variant of interest, the epoxidized polybutadiene is of Formula VI:

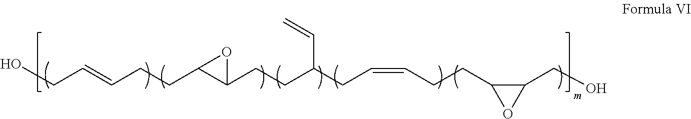

wherein,
m is an integer selected so that the mass average molecular weight of the epoxidized polybutadiene of Formula VI is between about 1,000 g/mol and about 1,500 g/mol as determined by GPC, upper and lower limits included; and
the epoxide equivalent weight is between about 100 g/mol and about 600 g/mol as determined by GPC, upper and lower limits included.

According to another example, the mass average molecular weight of the epoxidized polybutadiene comprising repeating units of Formulae III, IV, and V or the epoxidized polybutadiene of Formula VI is between about 1,050 g/mol and about 1,450 g/mol, or between about 1,100 g/mol and about 1,400 g/mol, or between about 1,150 g/mol and about 1,350 g/mol, or between about 1,200 g/mol and about 1,350 g/mol, or between about 1,250 g/mol and about 1,350 g/mol, as determined by GPC, upper and lower limits included. According to a variant of interest, the mass average molecular weight of the epoxidized polybutadiene comprising repeating units of Formulae III, IV, and V or of the epoxidized polybutadiene of Formula VI is about 1,300 g/mol, as determined by GPC.

According to another example, the epoxide equivalent weight of the epoxidized polybutadiene comprising repeating units of Formulae III, IV, and V or of the epoxidized polybutadiene of Formula VI is between about 150 g/mol and about 550 g/mol, or between about 200 g/mol and about 550 g/mol, or between about 210 g/mol and about 550 g/mol, or between about 260 g/mol and about 500 g/mol, as determined by GPC, upper and lower limits included. According to a variant of interest, the epoxide equivalent weight of the epoxidized polybutadiene comprising repeating units of Formulae III, IV, and V or of the epoxidized polybutadiene of Formula VI is between about 400 g/mol and about 500 g/mol, or between about 260 g/mol and about 330 g/mol as determined by GPC, upper and lower limits included.

For example, the epoxidized polybutadiene of Formula VI is a commercial hydroxyl-terminated epoxidized polybutadiene resin of the Poly bd™ 600E or 605E type marketed by Cray Valley. The physicochemical properties of these resins are presented in Table 1.

TABLE 1
Physical and chemical properties of
Poly bd 600E and 605E type resins

| Property | Poly bd 600E | Poly bd 605E |
|---|---|---|
| Epoxide value (meq/g) | 2-2.5 | 3-4 |
| Epoxide equivalent weight (g/mol) | 400-500 | 260-330 |
| Oxirane oxygen (%) | 3.4 | 4.8-6.2 |
| Viscosity at 30° C. (Pa · s) | 7 | 22 |
| Hydroxyl value (meq/g) | 1.70 | 1.74 |
| Molecular weight (g/mol) | 1 300 | 1 300 |

It is understood that the electrode binder comprises a polymer blend comprising at least one first polymer and at least one second polymer. The first polymer is the polybutadiene-based polymer, and the second polymer is the polynorbornene-based polymer comprising norbornene-based monomer units derived from polymerization of the compound of Formula I or the polymer of Formula II, 11(a), or II(b).

According to another example, the “first polymer second polymer” ratio is in the range of from about 6:1 to about 2:3, upper and lower limits included. For example, the “first polymer second polymer” ratio is in the range of from about 5.5:1 to about 2:3, or from about 5:1 to about 2:3, or from about 4.5:1 to about 2:3, or from about 4:1 to about 2:3, or from about 6:1 to about 1:1, or from about 5.5:1 to about 1:1, or from about 5:1 to about 1:1, or from about 4.5:1 to about 1:1, or from about 4:1 to about 1:1, upper and lower limits included. According to a variant of interest, the “first polymer second polymer” ratio is in the range of from about 4:1 to about 1:1, upper and lower limits included.

According to another example, the polymer blend of said electrode binder may be solubilized in at least one solvent. For example, the solvent may be selected for its ability to solubilize the polymer blend and to be effectively mixed therewith. For example, the solvent may be an organic solvent, for example, a polar aprotic solvent. For example, the solvent may be selected from the group consisting of dichloromethane (DCM), N,N-dimethylformamide (DMF), diethyl carbonate (DEC), N,N-dimethylacetamide (DMAC), N-methyl-2-pyrrolidone (NMP), dioxolane, dioxane, toluene, benzene, methoxybenzene, benzene derivatives, tetrahydrofuran (THF), and a miscible combination of at least two thereof. According to a variant of interest, the solvent is THF, a mixture comprising THF and methoxybenzene, a mixture comprising toluene and THF, a mixture comprising toluene and DEC, a mixture comprising toluene and DMAC, a mixture comprising p-xylene and THF, a mixture comprising m-xylene and THF, a mixture comprising o-xylene and THF, a mixture comprising p-xylene and DEC, a mixture comprising m-xylene and DEC, a mixture comprising o-xylene and DEC, or a mixture comprising toluene and methoxybenzene. Nevertheless, said solvent is preferably removed from the electrode in which the binder is found before it is assembled with other elements of an electrochemical cell.

The present technology also relates to the use of the electrode binder as defined herein in an electrode material. Indeed, an electrode material comprising an electrode material including an electrochemically active material and an electrode binder as defined herein is also contemplated.

According to an example, the electrode material as defined herein further includes an electronically conductive material. Non-limiting examples of electronically conductive material include a carbon source such as carbon black (for example, Keljen™ carbon and Super P™ carbon), acetylene black (for example, Shawinigan carbon and Denka™ carbon black), graphite, graphene, carbon fibers (for example, vapor grown carbon fibers (VGCFs)), carbon nanofibers, carbon nanotubes (CNTs) and a combination of at least two thereof.

According to another example, the electronically conductive material, if present in the electrode material, may be a modified electronically conductive material such as those described in PCT patent application published under number WO2019/218067 (Delaporte et al.). For example, the modified electronically conductive material may be grafted with at least one aryl group of Formula VII:

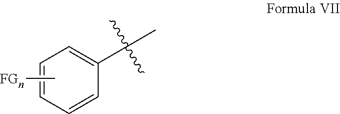

wherein,
FG is a hydrophilic functional group; and
n is an integer in the range of from 1 to 5, preferably n is in the range of from 1 to 3, preferably n is 1 or 2, or more preferably n is 1.

Examples of hydrophilic functional groups include hydroxyl, carboxyl, sulfonic acid, phosphonic acid, amine, amide, and other similar groups. For example, the hydrophilic functional group is a carboxyl or sulfonic acid functional group. Preferred examples of aryl groups of Formula VII include p-benzoic acid and p-benzenesulfonic acid.

According to a variant of interest, the electronically conductive material is carbon black optionally grafted with at least one aryl group of Formula VII. According to another variant of interest, the electronically conductive material may be a mixture comprising at least one modified electronically conductive material. For example, a mixture of carbon black grafted with at least one aryl group of Formula VII and carbon fibers (for example, vapor grown carbon fibers (VGCFs)), carbon nanofibers, carbon nanotubes (CNTs) or a combination of at least two thereof.

According to another example, said electrode material is a positive electrode material and the electrochemically active material is selected from a metal oxide, a metal sulfide, a metal oxysulfide, a metal phosphate, a metal fluorophosphate, a metal oxyfluorophosphate, a metal sulfate, a metal halide (for example, a metal fluoride), sulfur, selenium, and a combination of at least two thereof. According to another example, the metal of the electrochemically active material is selected from titanium (Ti), iron (Fe), manganese (Mn), vanadium (V), nickel (Ni), cobalt (Co), aluminum (Al), chromium (Cr), copper (Cu), zirconium (Zr), niobium (Nb), and combinations thereof, when compatible. The electrochemically active material may optionally further comprise an alkali or alkaline earth metal, for example, lithium (Li), sodium (Na), potassium (K), or magnesium (Mg).

Non-limiting examples of electrochemically active materials include lithium metal phosphates, complex oxides, such as LiM′PO₄ (where M′ is Fe, Ni, Mn, Co, or a combination thereof), LiV₃O₈, V₂O₅, LiMn₂O₄, LiM″O₂ (where M″ is Mn, Co, Ni, or a combination thereof), U(NiM″′)O₂ (where M″′ is Mn, Co, Al, Fe, Cr, Ti, or Zr, or a combination thereof), and combinations thereof, when compatible.

According to an example of interest, the electrochemically active material is an oxide, or a phosphate as described above.

For example, the electrochemically active material is a lithium manganese oxide, wherein manganese may be partially substituted with a second transition metal, such as lithium nickel manganese cobalt oxide (NMC). According to an alternative, the electrochemically active material is lithiated iron phosphate. According to another alternative, the electrochemically active material is a manganese-containing lithiated metal phosphate such as those described above, for example, the manganese-containing lithiated metal phosphate is a lithiated iron and manganese phosphate (LiMn₁₋ₓFeₓPO₄, where x is between 0.2 and 0.5).

According to another example, said electrode material is a negative electrode material and the electrochemically active material is selected from a non-alkali and non-alkaline earth metal (for example, indium (In), germanium (Ge), and bismuth (Bi)), an intermetallic compound (for example, SnSb, TiSnSb, Cu₂Sb, AlSb, FeSb₂, FeSn₂, and CoSn₂), a metal oxide, a metal nitride, a metal phosphide, a metal phosphate (for example, LiTi₂(PO₄)₃), a metal halide (for example, a metal fluoride), a metal sulfide, a metal oxysulfide, a carbon (for example, graphite, graphene, reduced graphene oxide, hard carbon, soft carbon, exfoliated graphite, and amorphous carbon), silicon (Si), a silicon-carbon composite (Si—C), a silicon oxide (SiOₓ), a silicon oxide-carbon composite (SiOₓ—C), tin (Sn), a tin-carbon composite (Sn—C), a tin oxide (SnOₓ), a tin oxide-carbon composite (SnOₓ—C), and their combinations, when compatible. For example, the metal oxide may be selected from compounds of formulae M″″_{b}O_{c} (where M″″ is Ti, Mo, Mn, Ni, Co, Cu, V, Fe, Zn, Nb, or a combination thereof, and b and c are numbers such that the ratio c:b is in the range of from 2 to 3) (for example, MoO₃, MoO₂, MoS₂, V₂O₅, and TiNb₂O₇), spinel oxides (for example, NiCo₂O₄, ZnCo₂O₄, MnCo₂O₄, CuCo₂O₄, and CoFe₂O₄), and LiM″″′O (where M is Ti, Mo, Mn, Ni, Co, Cu, V, Fe, Zn, Nb, or a combination of at least two thereof) (for example, a lithium titanate (such as Li₄Ti₅O₁₂) or a lithium molybdenum oxide (such as Li₂Mo₄O₁₃)).

According to another example, the electrochemically active material may optionally be doped with other included elements in smaller amounts, for example, to modulate or optimize its electrochemical properties. The electrochemically active material may be doped by partial substitution of the metal with other ions. For example, the electrochemically active material may be doped with a transition metal (for example, Ti, V, Cr, Mn, Fe, Co, Ni, Cu, Zn, or Y) and/or a metal other than a transition metal (for example, Mg, Al, or Sb).

According to another example, the electrochemically active material may be in the form of particles (for example, microparticles and/or nanoparticles) which may be freshly formed or from a commercial source. For example, the electrochemically active material may be in the form of particles coated with a layer of coating material in a core-shell type configuration. The coating material may be an electronically conductive material, such as a conductive carbon coating. The conductive carbon layer may also be optionally grafted with at least one aryl group of Formula VII. Alternatively, the coating material may allow to substantially reduce the interfacial reactions at the interface between the electrochemically active material and an electrolyte, for example, a solid electrolyte, and in particular a sulfide-based ceramic-type solid electrolyte (for example, based on Li₆PS₅Cl). For example, the coating material may be selected from Li₂SiO₃, Li₄Ti₅O₁₂, LiTaO₃, L₁AlO₂, Li₂O—ZrO₂, LiNbO₃, their combinations, when compatible, and other similar materials. According to a variant of interest, the coating material comprises UNbO₃.

According to another example, the electrode material as defined herein further includes an additive. For example, the additive is selected from ionically conductive materials, inorganic particles, glass or glass-ceramic particles, ceramic particles, including nano-ceramics (for example, Al₂O₃, TiO₂, SiO₂, and other similar compounds), salts (for example, lithium salts) and a combination of at least two thereof. For example, the additive may be an ionic conductor selected from LISICON, thio-LISICON, argyrodite, garnet, NASICON, perovskite type compounds, oxides, sulfides, sulfur halides, phosphates, thio-phosphates, in crystalline and/or amorphous form, and a combination of at least two thereof.

According to a variant of interest, the additive, if present in the electrode material, may be ceramic, glass, or glass-ceramic particles, in crystalline and/or amorphous form. For example, the ceramic, glass, or glass-ceramic particles may be based on fluoride, phosphide, sulfide, oxysulfide, oxide, or a combination of at least two thereof. Non-limiting examples of ceramic, glass, or glass-ceramic particles include inorganic compounds of the formulae MLZO (for example, M₇La₃Zr₂O₁₂, M₍₇₋ₐ₎La₃Zr₂AlbO₁₂, M₍₇₋ₐ₎La₃Zr₂GabO₁₂, M₍₇₋ₐ₎La₃Zr_{(2-b)}Ta_{b}O₁₂, and M₍₇₋ₐ₎La₃Zr_{(2-b)}Nb_{b}O₁₂); MLTaO (for example, M₇La₃Ta₂O₁₂, M₅La₃Ta₂O₁₂, and M₆La₃Ta_{1.5}Y_{0.5}O₁₂); MLSnO (for example, M₇La₃Sn₂O₁₂); MAGP (for example, M₁₊ₐAlₐGe₂₋ₐ(PO₄)₃); MATP (for example, M₁₊ₐAlₐTi₂₋ₐ(PO₄)₃); MLTiO (for example, M₃ₐLa_{(2/3-a)}TiO₃); MZP (for example, MₐZr_{b}(PO₄)ᵣ); MCZP (for example, MₐCa_{b}Zr_{c}(PO₄)_{d}); MGPS (for example, MₐGe_{b}P_{c}S_{d} such as M₁₀GeP₂Si₂); MGPSO (for example, MₐGe_{b}P_{c}S_{d}Oₑ); MSiPS (for example, MₐSi_{b}P_{c}S_{d} such as M₁₀SiP₂Si₂); MSIPSO (for example, MₐSi_{b}P_{c}S_{d}Oₑ); MSnPS (for example, MₐSn_{b}P_{c}S_{d} such as M₁₀SnP₂Si₂); MSnPSO (for example, MₐSn_{b}P_{c}S_{d}Oₑ); MPS (for example, MₐPbS_{c} such as M₇P₃S₁₁); MPSO (for example, MₐP_{b}S_{c}O_{d}); MZPS (for example, MₐZn_{b}P_{c}S_{d}); MZPSO (for example, M_{c}Zn_{b}P_{c}S_{d}Oₑ); XM₂S-yP₂S₅; XM₂S-yP₂S₅-zMX; XM₂S-yP₂S₅-zP₂O₅; XM₂S-yP₂S₅-zP₂O₅-wMX; xM₂S-yM₂O-zP₂S₅; xM₂S-yM₂O-zP₂S₅-wMX; xM₂S-yM₂O-zP₂S₅-wP₂O₅; xM₂S-yM₂O-zP₂S₅-wP₂O₅-vMX; xM₂S-ySiS₂; MPSX (for example, MₐPbSJ(_{d} such as M₇P₃S₁₁X, M₇P₂S₈X, and M₆PS₅X; MPSOX (for example, MₐPbS_{c}O_{d}Xₑ); MGPSX (for example, MₐGe_{b}P_{c}S_{d}Xₑ); MGPSOX (for example, MₐGe_{b}P_{c}S_{d}OₑX_{f}); MSiPSX (for example, MₐSi_{b}P_{c}S_{d}Xₑ); MSiPSOX (for example, MₐSi_{b}P_{c}S_{d}OₑX_{f}); MSnPSX (for example, MₐSn_{b}P_{c}S_{d}Xₑ); MSnPSOX (for example, MₐSn_{b}P_{c}S_{d}OₑX_{f}); MZPSX (for example, M₂Zn_{b}P_{c}S_{d}Xₑ); MZPSOX (for example, MₐZn_{b}P_{c}S_{d}OₑX_{f}); M₃OX; M₂HOX; M₃PO₄; M₃PS₄; and MₐPO_{b}N_{c} (where a=2b+3c−5);
wherein:
M is an alkali metal ion, an alkaline earth metal ion, or a combination thereof, and wherein when M comprises an alkaline earth metal ion, then the number of M is adjusted to achieve electroneutrality;
X is selected from F, Cl, Br, I, or a combination of at least two thereof;
a, b, c, d, e, and f are numbers other than zero and are, independently in each formula, selected to achieve electroneutrality; and
v, w, x, y, and z are numbers other than zero and are, independently in each formula, selected to obtain a stable compound.

For example, M is selected from Li, Na, K, Rb, Cs, Be, Mg, Ca, Sr, Ba, and a combination of at least two thereof. According to a variant of interest, M comprises U and may further comprise at least one of Na, K, Rb, Cs, Be, Mg, Ca, Sr, Ba, and a combination of at least two thereof. According to a variant of interest, M comprises Na, K, Mg, or a combination of at least two thereof.

For example, the additive, if it is present in the electrode material, may be sulfide-based ceramic particles, for example, argyrodite-type ceramic particles of formula Li₆PS₅X (where X is Cl, Br, I, or a combination of at least two thereof). According to a variant of interest, the additive is argyrodite Li₆PS₅Cl.

For example, the electrode material preparation process as defined herein further includes the use of a solvent, for example, an organic solvent. For instance, the solvent may provide an optimal viscosity for coating the electrode material of about 10,000 cP, and may be substantially removed in a post-coating drying step. For example, the solvent may be THE or methoxybenzene (or anisole).

The present technology also relates to an electrode comprising an electrode material as defined herein. According to an example, the electrode may be on a current collector (for example, an aluminum or a copper foil). Alternatively, the electrode may be a self-supported electrode.

The present technology also relates to an electrochemical cell comprising a negative electrode, a positive electrode, and an electrolyte, wherein at least one of the negative electrode or the positive electrode is as defined herein.

According to a variant of interest, the negative electrode is as defined herein. For example, the electrochemically negative electrode material may be selected for its electrochemical compatibility with the different elements of the electrochemical cell as defined herein. For example, the electrochemically active material of the negative electrode material may have a substantially lower oxidation-reduction potential than that of the electrochemically active material of the positive electrode.

According to another variant of interest, the positive electrode is as defined herein, and the negative electrode includes an electrochemically active material selected from all known compatible electrochemically active materials. For example, the electrochemically active material of the negative electrode may be selected for its electrochemical compatibility with the different elements of the electrochemical cell as defined herein. Non-limiting examples of electrochemically active materials of the negative electrode include alkali metals, alkaline earth metals, alloys comprising at least one alkali or alkaline earth metal, non-alkali and non-alkaline-earth metals (for example, indium (In), germanium (Ge), and bismuth (Bi)), and intermetallic alloys or compounds (for example, SnSb, TiSnSb, Cu₂Sb, AlSb, FeSb₂, FeSn₂, and CoSn₂). For example, the electrochemically active material of the negative electrode may be in the form of a film having a thickness in the range of from about 5 μm to about 500 μm, and preferably in the range of from about 10 μm to about 100 μm, upper and lower limits included. According to a variant of interest, the electrochemically active material of the negative electrode may comprise a film of metallic lithium or an alloy including metallic lithium.

According to another example, the positive electrode may be pre-lithiated and the negative electrode may be initially (i.e., before cycling the electrochemical cell) substantially or completely free of lithium. The negative electrode may be lithiated in situ during the cycling of said electrochemical cell, particularly during the first charge. According to an example, metallic lithium may be deposited in situ on the current collector (for example, a copper current collector) during the cycling of the electrochemical cell, particularly during the first charge. According to another example, an alloy including metallic lithium may be generated on the surface of a current collector (for example, an aluminum current collector) during the cycling of the electrochemical cell, particularly during the first charge. It is understood that the negative electrode may be generated in situ during the cycling of the electrochemical cell, particularly during the first charge.

According to another variant of interest, both the positive electrode and the negative electrode are as defined herein.

According to another example, the electrolyte may be selected for its compatibility with the different elements of the electrochemical cell. Any type of compatible electrolyte is contemplated. According to an example, the electrolyte is a liquid electrolyte comprising a salt in a solvent According to an alternative, the electrolyte is a gel electrolyte comprising a salt in a solvent and optionally a solvating polymer. According to another alternative, the electrolyte is a solid polymer electrolyte comprising a salt in a solvating polymer. According to another alternative, the electrolyte comprises an inorganic solid electrolyte material, for example, the electrolyte may be a ceramic-type solid electrolyte. According to another alternative, the electrolyte is a polymer-ceramic hybrid solid electrolyte.

According to another example, the salt, if it is present in the electrolyte, may be an ionic salt, such as a lithium salt. Non-limiting examples of lithium salts include lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (UDCTA), lithium bis(pentafluoroethylsulfonyl)imide (LiBETI), lithium difluorophosphate (UDFP), lithium tetrafluoroborate (UBF₄), lithium bis(oxalato)borate (LiBOB), lithium nitrate (LiNO₃), lithium chloride (UCI), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiOTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), lithium bis(1,2-benzenediolato(2-)-O,O′)borate Li[B(C₆O₂)₂](LiBBB), lithium difluoro(oxalato)borate (LiBF₂(C₂O₄)) (LiFOB), a salt of formula UBF₂O₄Rx (where R^{x}=C₂₋₄alkyl), and a combination of at least two thereof.

According to another example, the solvent, if it is present in the electrolyte, may be a non-aqueous solvent Non-limiting examples of solvents include cyclic carbonates such as ethylene carbonate (EC), propylene carbonate (PC), butylene carbonate (BC), and vinylene carbonate (VC); acyclic carbonates such as dimethyl carbonate (DMC), diethyl carbonate (DEC), ethylmethyl carbonate (EMC), and dipropyl carbonate (DPC); lactones such as γ-butyrolactone (γ-BL) and γ-valerolactone (γ-VL); acyclic ethers such as 1,2-dimethoxyethane (DME), 1,2-diethoxyethane (DEE), ethoxymethoxyethane (EME), trimethoxymethane, and ethylmonoglyme; cyclic ethers such as tetrahydrofuran, 2-methyltetrahydrofuran, 1,3-dioxolane, and dioxolane derivatives; and other solvents such as dimethylsulfoxide, formamide, acetamide, dimethylformamide, acetonitrile, propylnitrile, nitromethane, phosphoric acid triester, sulfolane, methylsulfolane, propylene carbonate derivatives, and mixtures thereof.

According to another example, the electrolyte is a gel electrolyte or a gel polymer electrolyte. The gel polymer electrolyte may comprise, for example, a polymer precursor and a salt (for example, a salt as defined above), a solvent (for example, a solvent as defined above), and a polymerization and/or crosslinking initiator, if necessary. Examples of gel electrolytes include, without limitation, gel electrolytes such as those described in PCT patent applications published under numbers WO2009/111860 (Zaghib et al.) and WO2004/068610 (Zaghib et al.).

According to another example, a gel electrolyte or liquid electrolyte as defined above may also impregnate a separator such as a polymer separator. Examples of separators include, but are not limited to, polyethylene (PE), polypropylene (PP), cellulose, polytetrafluoroethylene (PTFE), polyvinylidene fluoride (PVDF), and polypropylene-polyethylene-polypropylene (PP/PE/PP) separators. For example, the separator is a commercial polymer separator of the Celgard™ type.

According to another example, the electrolyte is a solid polymer electrolyte. For example, the solid polymer electrolyte composition may be selected from any known solid polymer electrolyte composition and may be selected for its compatibility with the different components of an electrochemical cell. Solid polymer electrolyte compositions generally comprise a salt as well as one or more solid polar polymer(s), optionally crosslinked. Polyether-type polymers, such as those based on polyethylene oxide (POE), may be used, but several other compatible polymers are also known for the preparation of solid polymer electrolytes and are also contemplated. The polymer may be crosslinked. Examples of such polymers include branched polymers, for example, star-shaped polymers or comb-shaped polymers such as those described in the PCT patent application published under number WO02003/063287 (Zaghib et al.).

According to another example, the solid polymer electrolyte composition may include a block copolymer composed of at least one lithium-ion solvating segment and optionally at least one crosslinkable segment Preferably, the lithium-ion solvating segment is selected from homo- or copolymers having repeating units of Formula VIII:

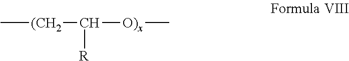

wherein,
R is selected from a hydrogen atom, and a C₁-C₁₀alkyl group or a —(CH₂—O—R^{a}R^{b}) group;
R^{a} is (CH₂—CH₂—O)_{y};
R^{b} is selected from a hydrogen atom and a C₁-C₁₀alkyl group;
x is an integer selected from the range of 10 to 200,000; and
y is an integer selected from the range of 0 to 10.

According to another example, the crosslinkable segment of the copolymer is a polymer segment comprising at least one functional group that is multi-dimensionally crosslinkable by irradiation or thermal treatment.

According to another example, the electrolyte comprises an ionically conductive inorganic solid electrolyte material and may comprise ceramic, glass, or glass-ceramic particles. For example, ceramic, glass, or glass-ceramic particles based on fluoride, phosphide, sulfide, oxysulfide, oxide, or a combination of at least two thereof. According to a variant of interest, the electrolyte comprises ceramic, glass, or glass-ceramic particles as described above.

According to another example, the electrolyte is a polymer-ceramic hybrid solid electrolyte, and may, for example, comprise particles of inorganic material as defined herein, previously dispersed in a solid polymer electrolyte as defined above. Alternatively, the polymer-ceramic hybrid solid electrolyte comprises a layer of ceramic electrolyte as defined above between two layers of solid polymer electrolyte as defined above.

According to another example, the electrolyte may also optionally include additives such as ionic conductive materials, inorganic particles, glass or ceramic particles as defined above, and other additives of the same type. According to another example, the additive may be a dicarbonyl compound such as those described in the PCT patent application published under number WO2018/116529 (Asakawa et al.). For example, the additive may be poly(ethylene-alt-maleic anhydride) (PEMA). The additive may be selected from all known electrolyte additives and can be selected for its compatibility with the different elements of the electrochemical cell. According to an example, the additive may be substantially dispersed in the electrolyte. Alternatively, the additive may be present in a separate layer.

According to an example, the electrode binder comprising a polymer blend as defined herein can significantly improve the dispersion of the different components of the positive electrode material, in particular the solid components. For example, the electrode binder comprising a polymer blend as defined herein can substantially promote the dispersion of the electrochemically active material, the electronically conductive material, and/or the ceramic-type solid electrolyte material. For example, the R¹ and/or R² groups of the polynorbornene-based polymer of the polymer blend of said binder may be groups that can promote dispersion of one of these materials. For example, carboxyl groups (—COOH) may be groups that can promote dispersion of one of these materials. Without wishing to be bound by theory, for example, repulsive interactions linked to the polymer blend of said material could allow better dispersion of the positive electrode components in the dispersion, and this, by the modification or not of the other components allowing this type of interaction. For example, repulsive interactions may be of the x-n and/or polar type.

According to another example, the different components of the positive electrode material can be modified in order to substantially increase repulsive interactions with the polymer mixture of said binder, and thus, to promote their dispersion. For example, the different components of the positive electrode can be modified by coating them with a coating material promoting repulsive interactions, for example, x-n and/or polar type interactions. According to an example, at least one of the electrochemically active material, the electronically conductive material, and the ceramic-type electrolyte material can be coated with a coating material that promotes repulsive interactions. For example, the coating material may comprise at least one branched or linear unsaturated aliphatic hydrocarbon having from 10 to 50 carbon atoms and having at least one carbon-carbon double or triple bond. For example, such a coating material may be a mixture comprising said unsaturated aliphatic hydrocarbon and an additional component. The additional component can be an alkane (for example, an alkane having from 10 to 50 carbon atoms) or a mixture comprising an alkane (for example, as defined herein) and a polar solvent (for example, tetrahydrofuran, acetonitrile, N, N-dimethylformamide, or a miscible combination of at least two thereof). According to a variant of interest, the additional component is decane or a mixture comprising decane and tetrahydrofuran. A conductive material, such as carbon, can also be modified by grafting groups, for example, as described in PCT patent application published under number WO02019/218067. According to an example, the electrochemical performance of the positive electrode material is not substantially negatively affected by these modifications and their interactions. The ionic and electronic conduction phenomena may even be enhanced, and the electrochemical double layer may present an improved stability.

The present technology also relates to a battery comprising at least one electrochemical cell as defined herein. For example, the battery may be a primary battery (cell) or a secondary battery (accumulator). According to an example, the battery is selected from the group consisting of a lithium battery, a lithium-ion battery, a sodium battery, a sodium-ion battery, a magnesium battery, a magnesium-ion battery, a potassium battery, and a potassium-ion battery. According to a variant of interest, the battery is an all-solid-state battery.

### EXAMPLES

The following examples are for illustrative purposes and should not be construed as further limiting the scope of the invention as contemplated. These examples will be better understood by referring to the accompanying figures.

### Example 1—Preparation of Argyrodite-Type Ceramic Particles of Formula L₆PS₅Cl

a) Coating of Li₆PS₅Cl Particles with a Mixture of Heptane and Dibutyl Ether (50:50 by Volume)

Coating of the Li₆PS₅Cl particles was carried out by a wet particle milling process.

Coating of the Li₆PS₅Cl particles was carried out during wet milling to reduce particle size using a PULVERISETTE™ 7 planetary micro mill. The coating material included a mixture of heptane and dibutyl ether (50:50 by volume). 4 g of Li₆PS₅Cl particles were placed in an 80 mL zirconium oxide (or zirconia) grinding jar. A mixture comprising 13 mL of heptane and 13 mL of anhydrous dibutyl ether (50:50 by volume) and grinding beads having a diameter of 2 mm were added to the jar. The Li₆PS₅Cl particles and the mixture of heptane and dibutyl ether were combined by grinding at a speed of about 300 rpm for about 7.5 hours to produce Li₆PS₅Cl particles coated with the mixture of heptane and dibutyl ether. The resulting particles were then dried under vacuum at a temperature of about 80° C.

b) Coating of Li₆PS₅Cl Particles with a Mixture of Decane and Squalene (75:25 by Volume)

Coating of the Li₆PS₅Cl particles was carried out by a wet milling and mechanosynthesis process.

Coating of the Li₆PS₅Cl particles was carried out using a PULVERISETTE™ 7 planetary micro mill. 4 g of Li₆PS₅Cl particles were placed in an 80 ml zirconium oxide grinding jar. A mixture comprising 20 ml of anhydrous decane and 7 ml of squalene (75:25 by volume) and grinding beads having a diameter of 2 mm were added to the jar. The Li₆PS₅Cl particles and the mixture of decane and squalene were combined by grinding at a speed of about 300 rpm for about 7.5 hours to produce Li₆PS₅Cl particles coated with the mixture of decane and squalene. The resulting particles were then dried under vacuum at a temperature of about 80° C.

c) Coating of Li₆PS₅Cl Particles with a Mixture of Decane and Squalene (90:10 by Volume)

Coating of the Li₆PS₅Cl particles was carried out by a wet milling and mechanosynthesis process.

Coating of the Li₆PS₅Cl particles was carried out using a PULVERISETTE™ 7 planetary micro mill. 4 g of Li₆PS₅Cl particles were placed in an 80 ml zirconium oxide grinding jar. A mixture of decane and squalene (90:10 by volume) and grinding beads having a diameter of 2 mm were added to the jar. The Li₆PS₅Cl particles and the mixture of decane and squalene were combined by grinding at a speed of about 300 rpm for about 7.5 hours to produce Li₆PS₅Cl particles coated with the mixture of decane and squalene. The resulting particles were then dried under vacuum at a temperature of about 80° C.

### Example 2—Preparation of the Modified Electronically Conductive Material

a) Grafting of Particles of Electronically Conductive Material with at Least One Aryl Group of Formula VII

The following process for the production of electronically conductive material was applied to carbon black.

5 g of carbon black were dispersed in 200 ml of a 0.5 M aqueous solution of sulfuric acid (H₂SO₄), then 0.01 equivalents of aniline p-substituted with a hydrophilic substituent (—SO₃H which was then lithiated in order to exchange the hydrogen with lithium) was added to the mixture (i.e., 0.01 equivalent of aniline relative to carbon black). The mixture was then stirred vigorously until the amine was completely dissolved.

After addition of 0.03 equivalents of sodium nitrite (NaNO₂) relative to carbon black (for example, 3 equivalents of NaNO₂ relative to aniline), the corresponding aryl diazonium ion was generated in situ and reacted with carbon black. The mixture thus obtained was left to react overnight at room temperature.

Once the reaction was complete, the mixture was filtered under vacuum using a vacuum filtration assembly (Buchner-type) and a nylon filter with a pore size of 0.22 μm. The modified carbon black powder thus obtained was then washed successively with deionized water until a neutral pH was reached, then with acetone. Finally, the modified carbon black powder was then dried under vacuum at 100° C. for at least one day before use.

b) Coating of Electronically Conductive Particles with a Mixture of Decane and Squalene (75:25 by Volume)

Coating of the electronically conductive material particles is carried out by a wet particle milling and mechanosynthesis process.

Coating of the carbon black particles is carried out using a PULVERISETTE™ 7 planetary micro mill. 4 g of carbon black particles are placed in an 80 ml zirconium oxide grinding jar. A mixture of anhydrous decane and squalene (75:25 by volume) and grinding beads having a diameter of 2 mm are added to the jar. The carbon black particles and the mixture of decane and squalene are combined by grinding at a speed of about 300 rpm for about 7.5 hours to produce carbon black particles coated with the mixture of decane and squalene. The resulting particles are then dried under vacuum at a temperature of about 80° C.

### Example 3—Preparation of the Positive Electrode Films

The composition of the positive electrode films is presented in Table 2.

TABLE 2
Composition of the positive electrode films

| | Composition of the positive electrode films | | | |
|---|---|---|---|---|
| | Electro- | | | |
| | chemically | Additive | Electronically | |
| | active | (coated | conductive | |
| Film | material | Li₆PS₅Cl) | material | Binder* |
| Film 1 | LiNbO₃ - | Prepared in | Unmodified | NBR |
| | NMC 622 | Example 1(a) | | |
| Film 2 | | Prepared in | Unmodified | PB and PNB |
| | | Example 1(a) | | (80:20 by weight) |
| Film 3 | | Prepared in | Prepared in | SBS |
| | | Example 1(b) | Example 2(a) | |
| Film 4 | | Prepared in | Prepared in | PB |
| | | Example 1(b) | Example 2(a) | |
| Film 5 | | Prepared in | Prepared in | PB and PNB |
| | | Example 1(b) | Example 2(a) | (80:20 by weight) |
| Film 6 | | Prepared in | Prepared in | SBS |
| | | Example 1(c) | Example 2(a) | |
| Film 7 | | Prepared in | Prepared in | PB and PNB |
| | | Example 1(c) | Example 2(a) | (80:20 by weight) |
| Film 8 | | Prepared in | Prepared in | PB and PNB |
| | | Example 1(c) | Example 2(a) | (70:30 by weight) |
| Film 9 | | Prepared in | Prepared in | PB and PNB |
| | | Example 1(c) | Example 2(a) | (60:40 by weight) |
| Film 10 | | Prepared in | Prepared in | PB and PNB |
| | | Example 1(c) | Example 2(a) | (50:50 by weight) |

*NBR: acrylonitrile-butadiene rubber; SBS: styrene-butadiene-styrene; PB: polybutadiene; PNB: polynorbornene of Formula II(b).

### a) Preparation of a Positive Electrode Film (Film 1)

1.55 g of LiNi_{0.6}Mn_{0.2}Co_{0.2}O₂ (NMC 622) particles coated with UNbO₃ from a commercial source having an average diameter of about 4 μm were mixed with 0.40 g of coated Li₆PS₅Cl particles prepared in Example 1(a) having an average diameter of about 200 nm and 0.5 g of carbon black in order to form a mixture of dry powders. The dry powders were mixed for about 10 minutes using a vortex mixer.

A polymer solution was prepared separately by dissolving 0.05 g of acrylonitrile-butadiene rubber (NBR) in 1.187 g of p-xylene. The polymer solution was added to the dry powder mixture. The mixture thus obtained was mixed for about 5 minutes using a planetary centrifugal mixer (Thinky Mixer). An additional quantity of solvent (p-xylene) was added to the mixture in order to achieve an optimal viscosity for coating, i.e., about 10,000 cP. The suspension thus obtained was coated onto an aluminum foil using a doctor blade coating method to obtain a positive electrode film applied on a current collector. The positive electrode film was then dried under vacuum at a temperature of about 120° C. for about 5 hours.

### b) Reparation of a Positive Electrode Film (Film 2)

1.55 g of NMC 622 particles coated with LiNbO₃ having an average diameter of about 4 μm were mixed with 0.40 g of coated Li₆PS₅Cl particles prepared in Example 1(a) having an average diameter of about 200 nm and 0.5 g of carbon black in order to form a mixture of dry powders. The dry powders were mixed for about 10 minutes using a vortex mixer.

A polymer solution was prepared separately by dissolving 0.04 g of polybutadiene and 0.01 g of polynorbornene in 0.94 g of THF. The polymer solution was added to the dry powder mixture. The mixture thus obtained was mixed for about 5 minutes using a planetary centrifugal mixer. An additional solvent, methoxybenzene, was added to the mixture in order to achieve an optimal viscosity for coating, i.e., about 10,000 cP. The suspension thus obtained was coated onto an aluminum foil using a doctor blade coating method to obtain a positive electrode film applied on a current collector. The positive electrode film was then dried under vacuum at a temperature of about 120° C. for about 5 hours.

### c) Reparation of a Positive Electrode Film (Film 3)

1.55 g of UNbO₃-coated NMC 622 particles having an average diameter of about 4 μm were mixed with 0.40 g of coated Li₆PS₅Cl particles prepared in Example 1(b) having an average diameter of about 200 nm and 0.5 g of modified carbon black in order to form a mixture of dry powders. The dry powders were mixed for about 10 minutes using a vortex mixer.

A polymer solution was prepared separately by dissolving 0.05 g of SBS in 0.94 g of methoxybenzene. The polymer solution was added to the dry powder mixture. The mixture thus obtained was mixed for about 5 minutes using a planetary centrifugal mixer. An additional quantity of methoxybenzene was added to the mixture to achieve an optimal viscosity for coating, i.e., about 10,000 cP. The suspension thus obtained was coated onto an aluminum foil using a doctor blade coating method to obtain a positive electrode film applied on a current collector. The positive electrode film was then dried under vacuum at a temperature of about 120° C. for about 5 hours.

### d) Preparation of a Positive Electrode Film (Film 4)

1.55 g of UNbO₃-coated NMC 622 particles having an average diameter of about 4 μm were mixed with 0.40 g of coated Li₆PS₅Cl particles prepared in Example 1(b) having an average diameter of about 200 nm and 0.5 g of modified carbon black in order to form a mixture of dry powders. The dry powders were mixed for about 10 minutes using a vortex mixer.

A polymer solution was prepared separately by dissolving 0.05 g of polybutadiene in 0.94 g of THF. The polymer solution was added to the dry powder mixture. The mixture thus obtained was mixed for about 5 minutes using a planetary centrifugal mixer. A quantity of methoxybenzene was added to the mixture to achieve an optimal viscosity for coating, i.e., about 10,000 cP. The suspension thus obtained was coated onto an aluminum foil using a doctor blade coating method to obtain a positive electrode film applied on a current collector. The positive electrode film was then dried under vacuum at a temperature of about 120° C. for about 5 hours.

### e) Reparation of a Positive Electrode Film (Film 5)

1.55 g of UNbO₃-coated NMC 622 particles having an average diameter of about 4 μm were mixed with 0.40 g of coated Li₆PS₅Cl particles prepared in Example 1(b) having an average diameter of about 200 nm and 0.5 g of modified carbon black in order to form a mixture of dry powders. The dry powders were mixed for about 10 minutes using a vortex mixer.

A polymer solution was prepared separately by dissolving 0.04 g of polybutadiene and 0.01 g of polynorbornene in 0.94 g of THF. The polymer solution was added to the dry powder mixture. The mixture thus obtained was mixed for about 5 minutes using a planetary centrifugal mixer. An additional quantity of solvent, methoxybenzene, was added to the mixture to achieve an optimal viscosity for coating, i.e., about 10,000 cP. The suspension thus obtained was coated onto an aluminum foil using a doctor blade coating method to obtain a positive electrode film applied on a current collector. The positive electrode film was then dried under vacuum at a temperature of about 120° C. for about 5 hours.

### i) Preparation of a Positive Electrode Film (Film 6)

1.55 g of UNbO₃-coated NMC 622 particles having an average diameter of about 4 μm were mixed with 0.40 g of coated Li₆PS₅Cl particles prepared in Example 1(c) having an average diameter of about 200 nm and 0.5 g of modified carbon black in order to form a mixture of dry powders. The dry powders were mixed for about 10 minutes using a vortex mixer.

A polymer solution was prepared separately by dissolving 0.05 g of SBS in 0.94 g of methoxybenzene. The polymer solution was added to the dry powder mixture. The mixture thus obtained was mixed for about 5 minutes using a planetary centrifugal mixer. An additional quantity of methoxybenzene was added to the mixture to achieve an optimal viscosity for coating, i.e., about 10,000 cP. The suspension thus obtained was coated onto an aluminum foil using a doctor blade coating method to obtain a positive electrode film applied on a current collector. The positive electrode film was then dried under vacuum at a temperature of about 120° C. for about 5 hours.

g) Reparation of a positive electrode film (Film 7) 1.55 g of UNbO₃-coated NMC 622 particles having an average diameter of about 4 μm were mixed with 0.40 g of coated Li₆PS₅Cl particles prepared in Example 1(c) having an average diameter of about 200 nm and 0.5 g of modified carbon black in order to form a mixture of dry powders. The dry powders were mixed for about 10 minutes using a vortex mixer.

A polymer solution was prepared separately by dissolving 0.04 g of polybutadiene and 0.01 g of polynorbornene in 0.94 g of THF. The polymer solution was added to the dry powder mixture. The mixture thus obtained was mixed for about 5 minutes using a planetary centrifugal mixer. An additional quantity of solvent, methoxybenzene, was added to the mixture to achieve an optimal viscosity for coating, i.e., about 10,000 cP. The suspension thus obtained was coated onto an aluminum foil using a doctor blade coating method to obtain a positive electrode film applied on a current collector. The positive electrode film was then dried under vacuum at a temperature of about 120° C. for about 5 hours.

### h) Reparation of a Positive Electrode Film (Film 8)

1.55 g of UNbO₃-coated NMC 622 particles having an average diameter of about 4 μm were mixed with 0.40 g of coated Li₆PS₅Cl particles prepared in Example 1(c) having an average diameter of about 200 nm and 0.5 g of modified carbon black in order to form a mixture of dry powders. The dry powders were mixed for about 10 minutes using a vortex mixer.

A polymer solution was prepared separately by dissolving 0.035 g of polybutadiene and 0.015 g of polynorbornene in 0.94 g of THF. The polymer solution was added to the dry powder mixture. The mixture thus obtained was mixed for about 5 minutes using a planetary centrifugal mixer. An additional quantity of solvent, methoxybenzene, was added to the mixture to achieve an optimal viscosity for coating, i.e., about 10,000 cP. The suspension thus obtained was coated onto an aluminum foil using a doctor blade coating method to obtain a positive electrode film applied on a current collector. The positive electrode film was then dried under vacuum at a temperature of about 120° C. for about 5 hours.

### i) Reparation of a Positive Electrode Film (Film 9)

1.55 g of UNbO₃-coated NMC 622 particles having an average diameter of about 4 μm were mixed with 0.40 g of coated Li₆PS₅Cl particles prepared in Example 1(c) having an average diameter of about 200 nm and 0.5 g of modified carbon black in order to form a mixture of dry powders. The dry powders were mixed for about 10 minutes using a vortex mixer.

A polymer solution was prepared separately by dissolving 0.030 g of polybutadiene and 0.020 g of polynorbornene in 0.94 g of THF. The polymer solution was added to the dry powder mixture. The mixture thus obtained was mixed for about 5 minutes using a planetary centrifugal mixer. An additional quantity of solvent, methoxybenzene, was added to the mixture to achieve an optimal viscosity for coating, i.e., about 10,000 cP. The suspension thus obtained was coated onto an aluminum foil using a doctor blade coating method to obtain a positive electrode film applied on a current collector. The positive electrode film was then dried under vacuum at a temperature of about 120° C. for about 5 hours.

### j) Preparation of a Positive Electrode Film (Film 10)

1.55 g of UNbO₃-coated NMC 622 particles having an average diameter of about 4 μm were mixed with 0.40 g of coated Li₆PS₅Cl particles prepared in Example 1(c) having an average diameter of about 200 nm and 0.5 g of modified carbon black in order to form a mixture of dry powders. The dry powders were mixed for about 10 minutes using a vortex mixer.

A polymer solution was prepared separately by dissolving 0.025 g of polybutadiene and 0.025 g of polynorbornene in 0.94 g of THF. The polymer solution was added to the dry powder mixture. The mixture thus obtained was mixed for about 5 minutes using a planetary centrifugal mixer. An additional quantity of solvent, methoxybenzene, was added to the mixture to achieve an optimal viscosity for coating, i.e., about 10,000 cP. The suspension thus obtained was coated onto an aluminum foil using a doctor blade coating method to obtain a positive electrode film applied on a current collector. The positive electrode film was then dried under vacuum at a temperature of about 120° C. for about 5 hours.

### Example 4—Characterization of the Positive Electrode Films Prepared in Examples 3(a) to 3(j)

Morphological studies of the different positive electrode films were carried out using a scanning electron microscope (SEM) equipped with an energy-dispersive X-ray spectrometer (EDS) detector.

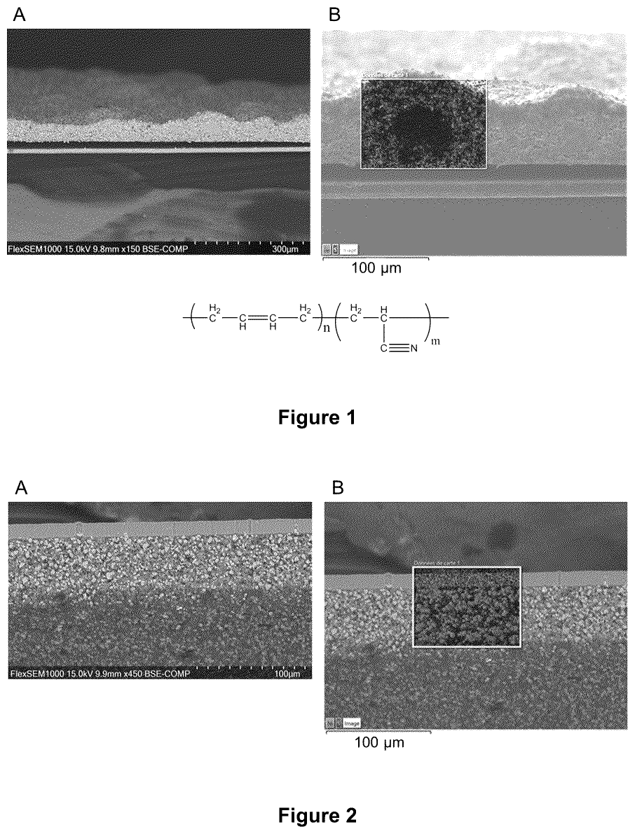

FIG. 1 shows in (A) an SEM image of the positive electrode film prepared in Example 3(a) (Film 1), and in (B) the corresponding EDS mapping image allowing the analysis of the distribution of the elements Ni and S. The scale bars represent 300 μm and 100 μm, respectively.

It is possible to observe in FIG. 1(A), the presence of waves on the surface of Film 1, and this, after the drying step of the positive electrode film. FIG. 1(B) confirms the presence of nickel (in green) in the electrochemically active material of the positive electrode (UNbO₃-NMC 622) and of sulfur (in red) in the solid electrolyte (coated Li₆PS₅Cl). FIG. 1 also shows the presence of sulfide agglomerates on the surface of Film 1. This indicates that the use of a solution of NBR dissolved in p-xylene in the suspension does not allow to disperse the solid electrolyte particles.

FIG. 2 shows in (A) an SEM image of the positive electrode film prepared in Example 3(b) (Film 2), and in (B) the corresponding mapping image allowing the analysis of the distribution of the elements Ni and S. The scale bars represent 100 μm.

It is possible to observe in FIG. 2(A) the absence of waves on the surface of Film 2, and this, after the drying step of the positive electrode film. FIG. 2(B) confirms the presence of nickel (in green) and of sulfur (in red). FIG. 2 also highlights the absence of sulfide agglomerates on the surface of Film 2. This indicates that the use of a solution comprising a blend of polybutadiene and polynorbornene (with —COOH groups) (80:20 by weight) dissolved in THE in the suspension allows the solid electrolyte particles to be adequately dispersed.

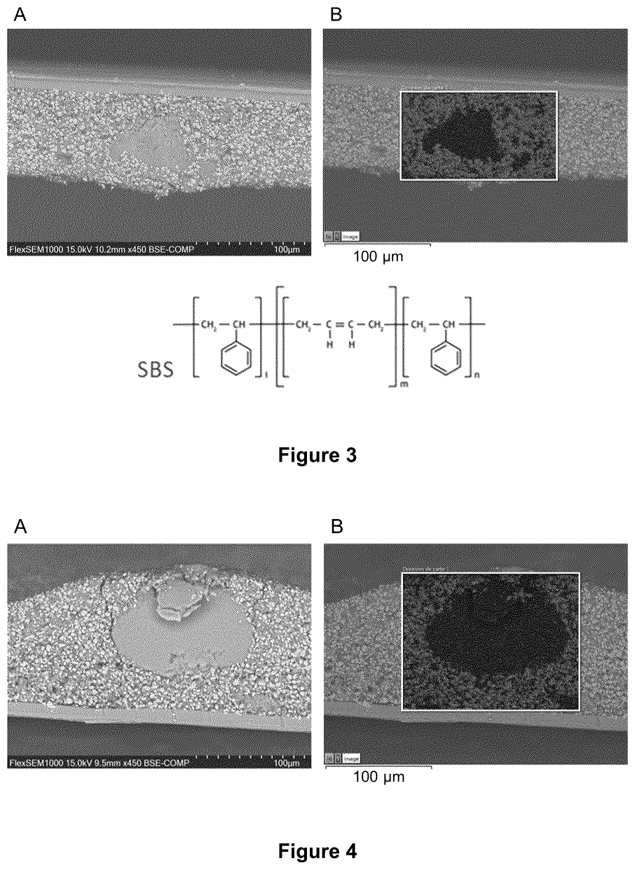

FIG. 3 shows in (A) an SEM image of the positive electrode film prepared in Example 3(c) (Film 3), and in (B) the corresponding EDS mapping image allowing the analysis of the distribution of the elements Ni and S. The scale bars represent 100 μm.

It is possible to observe in FIG. 3(A) the presence of a few waves on the surface of Film 3, and this, after the drying step of the positive electrode film. FIG. 3(B) confirms the presence of nickel (in green) and of sulfur (in red). FIG. 3 also highlights the presence of sulfide agglomerates on the surface of Film 3. This indicates that the use of a solution of SBS dissolved in methoxybenzene in the suspension does not allow to adequately disperse the solid electrolyte particles.

FIG. 4 shows in (A) an SEM image of the positive electrode film prepared in Example 3(d) (Film 4), and in (B) the corresponding EDS mapping image allowing the analysis of the distribution of the elements Ni and S. The scale bars represent 100 μm.

It is possible to observe in FIG. 4(A) the presence of a few waves on the surface of Film 4, and this, after the drying step of the positive electrode film. FIG. 4(B) confirms the presence of nickel (in green) and of sulfur (in red). FIG. 4 also highlights the presence of sulfide agglomerates on the surface of Film 4. This indicates that the use of a solution of polybutadiene dissolved in THF in the suspension does not allow to properly disperse the particles of solid electrolyte in the electrode material.

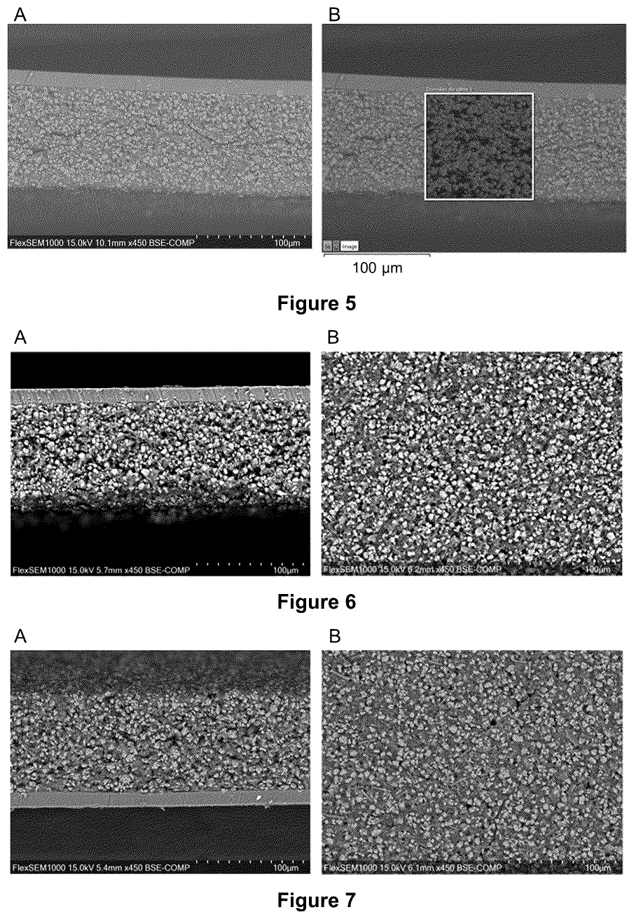

FIG. 5 shows in (A) an SEM image of the positive electrode film prepared in Example 3(e) (Film 5), and in (B) the corresponding EDS mapping image allowing the analysis of the distribution of the elements Ni and S. The scale bars represent 100 μm.

It is possible to observe in FIG. 5(A) the absence of waves on the surface of Film 5, and this, after the drying step of the positive electrode film. FIG. 5(B) confirms the presence of nickel (in green) and of sulfur (in red). FIG. 5 also highlights the absence of sulfide agglomerates on the surface of Film 5. This indicates that the use of a solution comprising a blend of polybutadiene and polynorbornene (with —COOH groups) (80:20 by weight) dissolved in THF in the suspension allows the solid electrolyte particles to be adequately dispersed. Without wishing to be bound by theory, this could be related to an effect of using polynorbornene modified with —COOH groups. The dispersion seems to be substantially favored by this type of group and by the carbon bridge linked to the polynorbornene structure itself. The coating of sulfide particles with molecules having double or triple bonds seems to substantially improve dispersion via π-π interactions and/or polar repulsions.

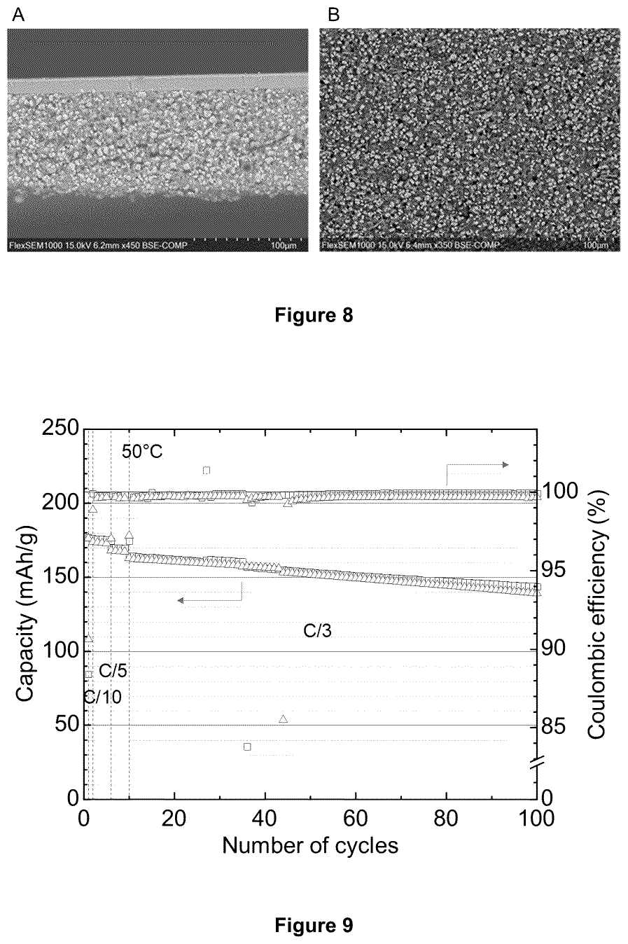

FIGS. 6 to 8 show in (A) SEM images of the positive electrode films prepared respectively in Examples 3(g) to 3(i) (Films 7 to 9), and in (B) a top-view SEM image of the same films. The scale bars represent 100 μm.

FIGS. 6 to 8 show good dispersion of the components in these positive electrode films. This indicates that the use of a solution comprising a blend of polybutadiene and polynorbornene (with —COOH groups) dissolved in THF allows to adequately disperse the coated Li₆PS₅Cl particles and the electronically conductive material through n-n interactions and polar repulsions.

### Example 5—Electrochemical Properties

The electrochemical properties of the positive electrode films prepared in Examples 3(a) to 3(j) were studied.

### a) Electrochemical Cell Configurations

The electrochemical cells were assembled according to the following procedure.

Pellets of 10 mm in diameter were taken from the positive electrode films prepared in Examples 3(a) to 3(j). Ceramic-type inorganic solid electrolytes based on Li₆PS₅Cl sulfides were prepared by placing 80 mg of ceramic on the surface of the positive electrode films.

The positive electrode film pellets including the inorganic solid electrolyte layer were then compressed under a pressure of 2.8 tons using a press. They were then assembled, in a glovebox, in CR2032 type button cell cases facing 10 mm diameter metallic lithium electrodes on copper current collectors. The electrochemical cells were assembled according to the configurations presented in Table 3.

TABLE 3
Electrochemical cell configurations

| Cell | Positive electrode film | Negative electrode |
|---|---|---|
| Cell 1 | Film 1 | Metallic lithium |
| Cell 2 | Film 2 | Metallic lithium |
| Cell 3 | Film 3 | Metallic lithium |
| Cell 4 | Film 4 | Metallic lithium |
| Cell 5 | Film 5 | Metallic lithium |
| Cell 6 | Film 6 | Metallic lithium |
| Cell 7 | Film 7 | Metallic lithium |
| Cell 8 | Film 8 | Metallic lithium |
| Cell 9 | Film 9 | Metallic lithium |
| Cell 10 | Film 10 | Metallic lithium |

### b) Behavior of the Positive Electrode Films

This example illustrates the electrochemical behavior of the electrochemical cells described in Example 5(a).

The electrochemical cells assembled in Example 5(a) were cycled between 4.3 V and 2.5 V vs Li/Li⁺. Cells 1 to 5 were cycled at a temperature of 50° C. and Cells 6 to 10 were cycled at a temperature of 30° C. The formation cycle was performed at a constant charge and discharge current of C/15. Then four cycles were performed at a constant charge and discharge current of C/10 followed by four cycles at a constant charge and discharge current of C/5. Finally, the long cycling experiments were carried out at a constant charge and discharge current of C/3.

FIG. 9 shows a graph of the discharge capacity (mAh/g) and the coulombic efficiency (%) as a function of the number of cycles for Cells 1 (▪) and 2(▴). It is possible to observe that there is no substantial difference in capacity retention for Cells 1 and 2. Indeed, the curves are substantially superimposed for the cycling at 50° C. of Cells 1 and 2.

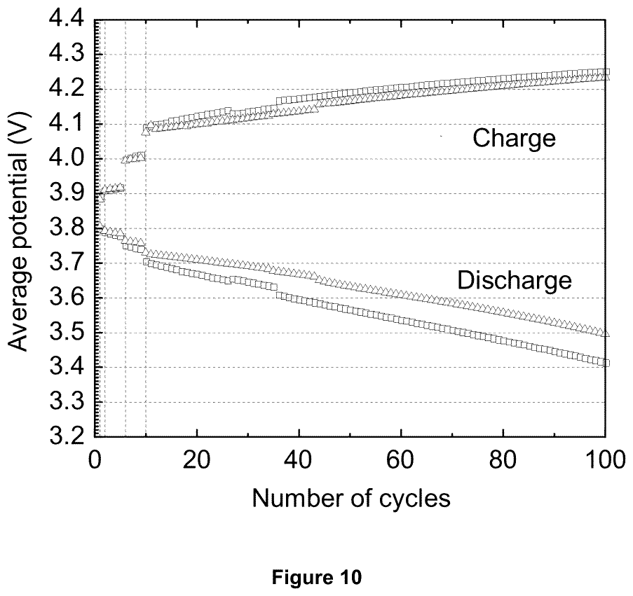

FIG. 10 shows a graph of the average charge and discharge potential (V) as a function of the number of cycles for Cells 1 (▪) and 2 (▴). It is possible to observe that Cell 2 comprising a blend of polybutadiene and polynorbornene (with —COOH groups) (80:20 by weight) as binder allows to obtain a lower polarization during long cycling experiments at a temperature of 50° C. and a constant charge and discharge current of C/3. It is also possible to observe a better discharge stability with the blend of polybutadiene and polynorbornene (with —COOH groups) (80:20 by weight). Thus, this polymer blend ensures better dispersion of the components of the electrode and therefore better ionic and electronic percolation of said components without substantially affecting charge transfer.

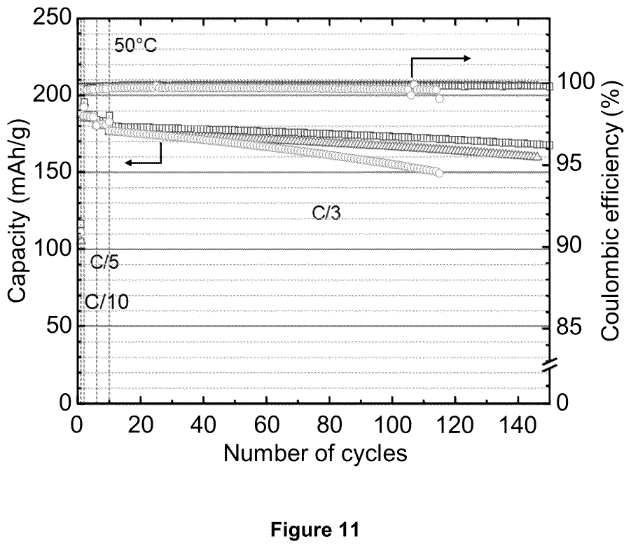

FIG. 11 shows a graph of the discharge capacity and the coulombic efficiency as a function of the number of cycles for Cells 3 (▪), 4 (●), and 5 (▴). It can be observed that capacity retention at a temperature of 50° C. and C/3 is improved when polybutadiene is used in combination with styrene or polynorbornene as a binder. Indeed, Cells 3 and 5 respectively comprising a copolymer of styrene and butadiene (styrene-butadiene-styrene (SBS)) and a blend of polybutadiene and polynorbornene present an improvement in capacity retention compared with Cell 4 comprising polybutadiene.

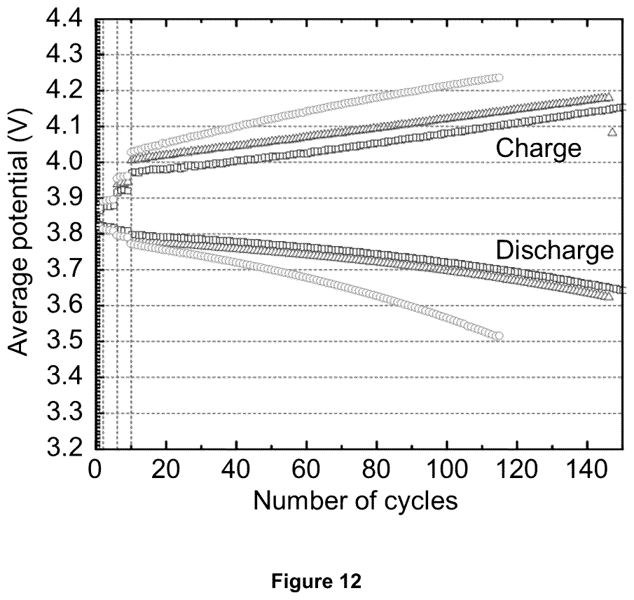

FIG. 12 shows a graph of the average charge and discharge potential as a function of the number of cycles (in connection to FIG. 11) for Cells 3 (▪), 4 (●), and 5 (▴). It is possible to observe that Cells 3 and 5 allow to obtain improved polarization during long cycling experiments compared with Cell 4. This can be attributed to the cohesive effect provided by styrene or polynorbornene, and therefore, confirms the positive and dispersive effect associated with the use of polynorbornene. Its complementarity with a more elastic polymer thus ensures cohesion during cycling, while allowing breathability of the system.

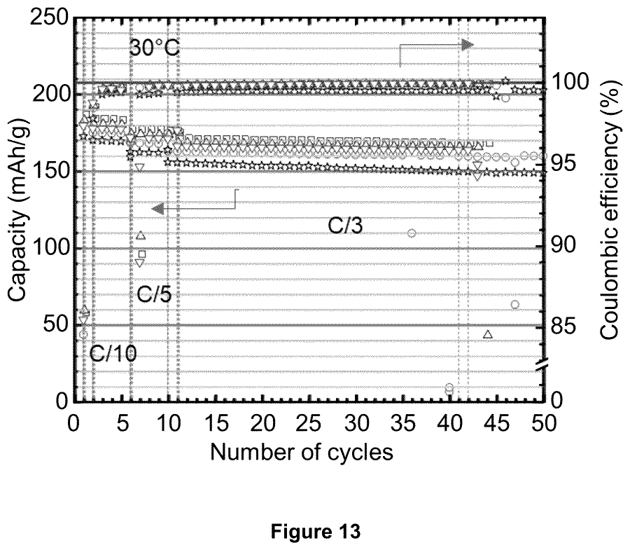

FIG. 13 shows a graph of the discharge capacity and the coulombic efficiency as a function of the number of cycles, and in (B) a graph of the average charge and discharge potential as a function of the number of cycles for Cells 6 (▪), 7 (▴), 8 (●), 9 (▾), and 10 (★).

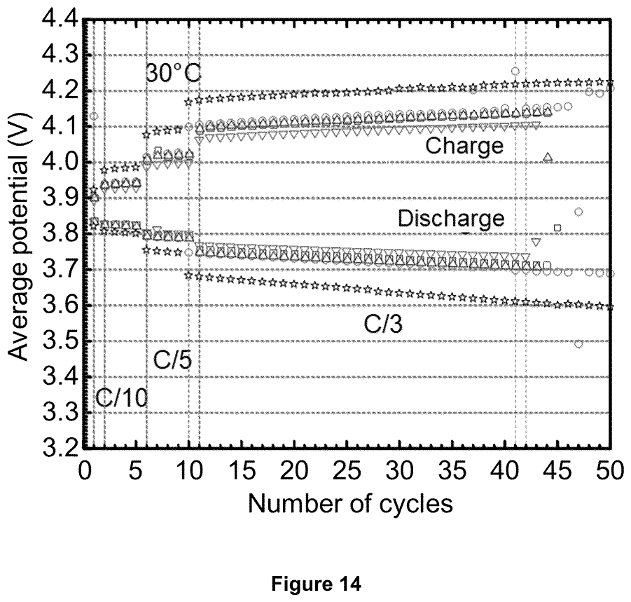

FIG. 14 shows a graph of the average charge and discharge potential as a function of the number of cycles associated with FIG. 13 for Cells 6 (▪), 7 (▴), 8 (●), 9 (▾), and 10 (★).

The retention of capacity in cycling at C/3 and 30° C. is slightly impacted by the change in formulation to the extent that there is a polymer which can provide a cohesive effect (styrene or polynorbornene).

A lower polarization can be observed for the positive electrode film comprising a blend of polybutadiene and polynorbornene (60:40 by weight) (Film 9) as a binder, especially in charge. This can be attributed to the dispersive effect of polynorbornene via the —COOH groups and carbon bridge that it possesses, coupled with the repulsive and π-π interactions of the carbons modified with polar groups and the coating of the sulfide particles with organic species having double or triple bonds. The cohesive nature provided by the increase in polynorbornene vs. polybutadiene ratio makes ensures stability during cycling, while maintaining the particles and the contact between these particles, while the polybutadiene absorbs the volume variations of the active material during cycling.

Several modifications could be made to any of the above-described embodiments without departing from the scope of the present invention as contemplated. The references, patents or scientific literature documents referred to in the present application are incorporated herein by reference in their entirety for all purposes.

What is claimed is:

1. A binder composition comprising a blend comprising a polybutadiene-based polymer and a polynorbornene-based polymer comprising norbornene-based monomer units derived from polymerization of a compound of Formula I: 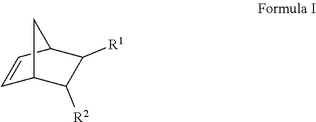
wherein,
R¹ and R² are independently and in each occurrence selected from a hydrogen atom, a carboxyl group (—COOH), a sulfonic acid group (—SO₃H), a hydroxyl group (—OH), a fluorine atom, and a chlorine atom, preferably R¹ and R² are independently and in each occurrence selected from a hydrogen atom and a —COOH group, and more preferably R¹ is a —COOH group and R² is a hydrogen atom or R¹ and R² are both —COOH groups.

2. The binder composition of claim 1, wherein the polynorbornene-based polymer is a polymer of Formula II: 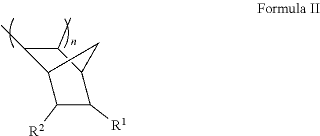
wherein,
R¹ and R² are as defined in claim 1, and
n is an integer selected so that the mass average molecular weight of the polymer of Formula II is between about 10,000 g/mol and about 100 000 g/mol, preferably between about 12,000 g/mol and about 85,000 g/mol, or between about 15,000 g/mol and about 75,000 g/mol, or between about 20,000 g/mol and about 65,000 g/mol, or between about 25,000 g/mol and about 55,000 g/mol, or between about 25,000 g/mol and about 50,000 g/mol, upper and lower limits included.

3-6. (canceled)

7. The binder composition of claim 1, wherein the polybutadiene-based polymer is polybutadiene or is selected from epoxidized polybutadienes.

8. (canceled)

9. The binder composition of claim 78, wherein the epoxidized polybutadiene comprises repeating units of Formulae III, IV, and V: 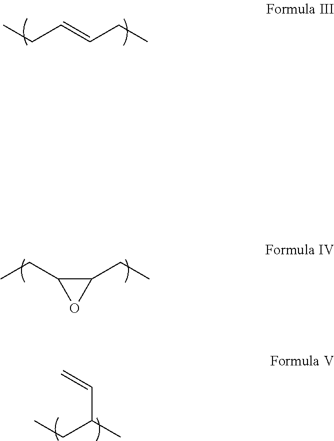
and two hydroxyl end groups.

10. The binder composition of claim 9, wherein the epoxidized polybutadiene is of Formula VI: 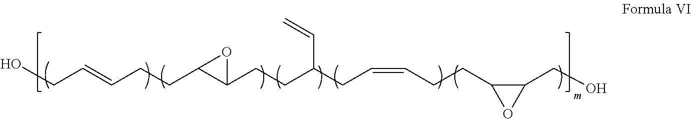
wherein,
m is an integer selected so that the mass average molecular weight of the epoxidized polybutadiene of Formula VI is between about 1,000 g/mol and about 1,500 g/mol, upper and lower limits included, the mass average molecular weight of the epoxidized polybutadiene of Formula VI is about 1,300 g/mol; and
the epoxide equivalent weight is between about 100 g/mol and about 600 g/mol, and preferably between about 210 g/mol and about 550 g/mol, and lower limits included.

11-12. (canceled)

13. The binder composition of claim 10, wherein the epoxidized polybutadiene of Formula VI is a Poly bd™ 600E resin with a mass average molecular weight of about 1,300 g/mol and an epoxide equivalent weight of between about 400 g/mol and about 500 g/mol, upper and lower limits included or is a Poly bd™ 605E resin with a mass average molecular weight of about 1,300 g/mol and an epoxide equivalent weight of between about 260 g/mol and about 330 g/mol, upper and lower limits included.

14. (canceled)

15. The binder composition of claim 1, wherein the weight ratio of polybutadiene-based polymer: polynorbornene-based polymer is in the range of from about 6:1 to about 2:3, upper and lower limits included, preferably the weight ratio is in the range of from about 5.5:1 to about 2:3, or from about 5:1 to about 2:3, or from about 4.5:1 to about 2:3, or from about 4:1 to about 2:3, or from about 6:1 to about 1:1, or from about 5.5:1 to about 1:1, or from about 5:1 to about 1:1, or from about 4.5:1 to about 1:1, or from about 4:1 to about 1:1, upper and lower limits included, and more preferably the weight ratio is in the range of from about 4:1 to about 1:1, upper and lower limits included.

16-17. (canceled)

18. The binder composition of claim 1, further comprising at least one solvent preferably being an aprotic solvent, and preferably wherein;
the aprotic solvent is selected from the group consisting of dichloromethane (DCM), N,N-dimethylformamide (DMF), diethyl carbonate (DEC), N,N-dimethylacetamide (DMAC), N-methyl-2-pyrrolidone (NMP), dioxolane, dioxane, toluene, benzene, methoxybenzene, benzene derivatives, tetrahydrofuran (THF), and a miscible combination of at least two thereof;
the aprotic solvent is selected from the group consisting of dichloromethane (DCM), N,N-dimethylformamide (DMF), diethyl carbonate (DEC), N,N-dimethylacetamide (DMAC), N-methyl-2-pyrrolidone (NMP), dioxolane, dioxane, toluene, benzene, methoxybenzene, benzene derivatives, tetrahydrofuran (THF), and a miscible combination of at least two thereof;
the aprotic solvent is THF, a mixture comprising THF and methoxybenzene, a mixture comprising toluene and THF, a mixture comprising toluene and DEC, a mixture comprising toluene and DMAC, a mixture comprising p-xylene and THF, a mixture comprising m-xylene and THF, a mixture comprising o-xylene and THF, a mixture comprising p-xylene and DEC, a mixture comprising m-xylene and DEC, a mixture comprising o-xylene and DEC, or a mixture comprising toluene and methoxybenzene, or
the aprotic polar solvent is THF or a mixture comprising THF and methoxybenzene.

19-22. (canceled)

23. A binder comprising a binder composition as defined in claim 1, said binder preferably being used in an electrode material.

24. (canceled)

25. An electrode material comprising an electrochemically active material and a binder composition as defined in claim 1 or a binder comprising a binder composition as defined in claim 1.

26. The electrode material of claim 25, wherein:
the electrochemically active material is selected from a metal oxide, a metal sulfide, a metal oxysulfide, a metal phosphate, a metal fluorophosphate, a metal oxyfluorophosphate, a metal sulfate, a metal halide, a metal fluoride, sulfur, selenium, and a combination of at least two thereof; the metal of the electrochemically active material preferably being selected from titanium (Ti), iron (Fe), manganese (Mn), vanadium (V), nickel (Ni), cobalt (Co), aluminum (Al), chromium (Cr), copper (Cu), zirconium (Zr), niobium (Nb), and a combination of at least two thereof; and preferably the electrochemically active material further comprises an alkali of alkaline earth metal selected from lithium (Li), sodium (Na), potassium (K), and magnesium (Mg);
the electrochemically active material is a lithium metal oxide, and preferably the lithium metal oxide is a mixed oxide of lithium, nickel, manganese, and cobalt (NMC);
the electrochemically active material is a lithiated metal phosphate, and preferably the lithiated metal phosphate is lithiated iron phosphate;
the electrochemically active material is selected from a non-alkali or non-alkaline-earth metal, an intermetallic compound, a metal oxide, a metal nitride, a metal phosphide, a metal phosphate, a metal halide, a metal fluoride, a metal sulfide, a metal oxysulfide, a carbon, silicon (Si), a silicon-carbon composite (Si—C), a silicon oxide (SiOₓ), a silicon oxide-carbon composite (SiOₓ—C), tin (Sn), a tin-carbon composite (Sn—C), a tin oxide (SnOₓ), a tin oxide-carbon composite (SnOₓ—C), and a combination of at least two thereof; or
the electrochemically active material further comprises a doping element.

27-34. (canceled)

35. The electrode material of claim 25, wherein the electrochemically active material is in particulate form further optionally comprising a coating material, and preferably wherein:
the coating material is selected from Li₂SiO₃, Li₄Ti₅O₁₂, LiTaO₃, LiAlO₂, Li₂O—ZrQ₂, LiNbO₃, other similar materials, and a combination of at least two thereof, and preferably the coating material is LiNbO₃; or
the coating material is an electrochemically conductive material, and preferably the electronically conductive material is carbon.

36-40. (canceled)

41. The electrode material of claim 25, further comprising an electronically conductive material, preferably wherein:
the electronically conductive material is selected from the group consisting of carbon black, acetylene black graphite, graphene, carbon fibers, carbon nanofibers, carbon nanotubes, and a combination of at least two thereof;
the electronically conductive material is carbon black; and/or
the surface of said electronically conductive material is grafted with at least one aryl group of Formula VII: 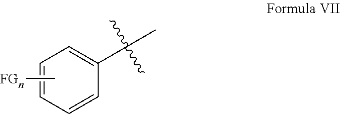
wherein,
FG is a hydrophilic functional group preferably being a carboxylic acid group or a sulfonic acid functional group; and
n is an integer in the range of from 1 to 5, preferably n is in the range of from 1 to 3, preferably n is 1 or 2, or more preferably n is 1;
the aryl group of Formula I preferably being p-benzoic acid or p-benzenesulfonic acid.

42-46. (canceled)

47. The electrode material of claim 25, further comprising an additive, and preferably wherein:
(i) the additive is selected from ionic conductive materials, inorganic particles, glass or glass-ceramic panicles, ceramic particles, nano-ceramics, salts, and a combination of at least two thereof;
(ii) the additive comprises ceramic, glass, or glass-ceramic particles based on fluoride, phosphide, sulfide, oxysulfide, or oxide;
(iii) the additive is selected from LISICON, thio-LISICON, argyrodite, garnet, NASICON, perovskite type compounds, oxides, sulfides, oxysulfides, phosphides, fluorides, in crystalline and/or amorphous form, and a combination of at least two thereof;
(iv) the additive is selected from inorganic compounds of the formulae:
MLZO (for example, M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎ La₃Zr_{(2-b)}Ta_{b}O₁₂, and M₍₇₋ₐ₎La₃Zr_{(2-b)}Nb_{b}O₁₂);
MLTaO (for example, M₇La₃Ta₂O₁₂, M₅La₃Ta₂O₁₂, and M₆La₃Ta_{1.5}Y_{0.5}O₁₂);
MLSnO (for example, M₇La₃Sn₂O₁₂);
MAGP (for example, M₁₊ₐAlₐGe₂₋ₐ(PO₄)₃);
MATP (for example, M₃ₐLa_{(2/3-a)}TiO₃);
MLTiO (for example, M₃ₐLa_{(2/3-a)}TiO₃);
MZP (for example, MₐZn_{b}(PO₄)_{c});
MCZP (for example, MₐCa_{b}Zr_{c}(PO₄)_{d});
MGPS (for example, MₐGe_{b}P_{c}S_{d} such as M₁₀GeP₂S₁₂):
MGPSO (for example, MₐGe_{b}P_{c}S_{d}Oₑ);
MSiPS (for example, MₐSi_{b}P_{c}S_{d} such as M₁₀SiP₂S₁₂);
MSiPSO (for example, MₐSi_{b}P_{c}S_{d}Oₑ);
MSnPS (for example, MₐSn_{b}P_{c}S_{d} such as M₁₀SnP₂S₁₂);
MPS (for example, MₐP_{b}S_{c} such as M₇P₃S₁₁);
MPSO (for example, MₐP_{b}S_{c}O_{d});
MZPS (for example, MₐZn_{b}P_{c}S_{d});
MZPSO (for example, MₐZn_{b}P_{c}S_{d}Oₑ);
xM₂S-yP₂S₅;
xM₂s-yP₂S₅-zMX;
xM₂S-yP₂S₅-zP₂O₅;
xM₂S-yP₂S₅-zP₂O₅-wMX;
xM₂S-yM₂O-zP₂S₅;
xM₂S-yM₂O-zP₂S₅-wMX;
xM₂S-yM₂O-zP₂S₅-wP₂O₅;
xM₂S-yM₂O-zP₂S₅-wP₂O₅-vMX;
xM₂S-ySiS₂;
MPSX (or example MₐP_{b}S_{c}X_{d} such as M₇P₂S₈X, and M₆PS₅X);
MPSOX (for example, MₐP_{b}S_{c}O_{d}Xₑ);
MGPSX (for example, MₐGe_{b}P_{c}S_{d}Xₑ);
MGPSOX (for example, MₐGe_{b}P_{c}S_{d}OₑX_{f});
MSiPSX (for example, MₐSi_{b}P_{c}S_{d}Xₑ);
MSiPSOX (for example, MₐSi_{b}P_{c}S_{d}OₑX_{f});
MSnPSX (for example, MₐSn_{b}P_{c}S_{d}Xₑ);
MSnPSOX (for example, MₐSn_{b}P_{c}S_{d}OₑX_{f});
MZPSX (for example, MₐZn_{b}P_{c}S_{d}Xₑ);
MZPSOX (for example, MₐZn_{b}P_{c}S_{d}OₑX_{f});
M₃OX;
M₂HOX;
M₃PO₄;
M₃PS₄; and
MₐPO_{b}N_{c}(where a=; 2b+3c−5);
wherein:
M is an alkali metal ion, an alkaline earth metal ion, or a combination thereof, and wherein when M comprises an alkaline earth metal ion, then the number of M is adjusted to achieve electroneutrality, preferably M is selected from Li, Na, K, Rb, Cs, Be, Mg, Ca, Sr, Ba, and a combination of at least two thereof, and more preferably M is Li;
X is selected from F, Cl, Br, I, or a combination of at least two thereof,
a, b, c, d, e, and fare numbers other than zero and are independently in each formula, selected to achieve electroneutrality; and
v, w, x, y, and z are numbers other than zero and are, independently in each formula, selected to obtain a stable compound,
(v) the additive is selected from inorganic argyrodite-type compounds of formula Li₆PS₅X, wherein X is Cl, Br, I, on a combination of at least two thereof; or
(vi) the additive is Li₆PS₅Cl.

48-55. (canceled)

56. An electrode comprising the electrode material as defined in claim 25, said electrode being a self-supported electrode or being on a current collector.

57. (canceled)

58. An electrochemical cell comprising a negative electrode, a positive electrode, and an electrolyte, wherein at least one of the positive electrode or the negative electrode comprises an electrode material as defined in claim 25.

59. The electrochemical cell of claim 58, wherein the electrolyte is a liquid electrolyte comprising a salt in a solvent, or is a gel electrolyte comprising a salt in a solvent and optionally a solvating polymer, or is a solid polymer electrolyte comprising a salt in a solvating polymer, or is a polymer-ceramic hybrid solid electrolyte, or comprises an inorganic solid electrolyte material.

60-63. (canceled)

64. The electrochemical cell of claim 59, wherein:
(i) the inorganic solid electrolyte material comprises ceramic, glass, or glass-ceramic particles based on fluoride, phosphide, sulfide, oxysulfide, or oxide;
(ii) the inorganic solid electrolyte material is selected from LISICON, thio-LISICON, argyrodite, garnet, NASICON, perovskite type compounds, oxides, sulfides, oxysulfides, phosphides, fluorides, in crystalline and/or amorphous form, and a combination of at least two thereof;
(iii) the inorganic solid electrolyte material is selected from inorganic compounds of the formulae:
MLZO (for example, M₇La₃Zr₂O₁₂, M₍₇₋ₐ₎La₃Zr₂Al_{b}O₁₂, M₍₇₋ₐ₎La₃Zr₂Ga_{b}O₁₂, M₍₇₋ₐ₎ La₃Zr_{(2-b)}Ta_{b}O₁₂, and M₍₇₋ₐ₎La₃Zr_{(2-b)}Nb_{b}O₁₂);
MLTaO (for example, M₇La₃Ta₂O₁₂, M₅La₃Ta₂O₁₂, and M₆La₃Ta_{1.5}Y_{0.5}O₁₂);
MLSnO (for example, M₇La₃Sn₂O₁₂);
MAGP (for example, M₁₊ₐAlₐGe₂₋ₐ(PO₄)₃);
MATP (for example, M₃ₐLa_{(2/3-a)}TiO₃);
MLTiO (for example, M₃ₐLa_{(2/3-a)}TiO₃);
MZP (for example, MₐZn_{b}(PO₄)_{c});
MCZP (for example, MₐCa_{b}Zr_{c}(PO₄)_{d});
MGPS (for example, MₐGe_{b}P_{c}S_{d} such as M₁₀GeP₂S₁₂):
MGPSO (for example, MₐGe_{b}P_{c}S_{d}Oₑ);
MSiPS (for example, MₐSi_{b}P_{c}S_{d} such as M₁₀SiP₂S₁₂);
MSiPSO (for example, MₐSi_{b}P_{c}S_{d}Oₑ);
MSnPS (for example, MₐSn_{b}P_{c}S_{d} such as M₁₀SnP₂S₁₂);
MPS (for example, MₐP_{b}S_{c} such as M₇P₃S₁₁);
MPSO (for example, MₐP_{b}S_{c}O_{d});
MZPS (for example, MₐZn_{b}P_{c}S_{d});
MZPSO (for example, MₐZn_{b}P_{c}S_{d}Oₑ);
xM₂S-yP₂S₅;
xM₂s-yP₂S₅-zMX;
xM₂S-yP₂S₅-zP₂O₅;
xM₂S-yP₂S₅-zP₂O₅-wMX;
xM₂S-yM₂O-zP₂S₅;
xM₂S-yM₂O-zP₂S₅-wMX;
xM₂S-yM₂O-zP₂S₅-wP₂O₅;
xM₂S-yM₂O-zP₂S₅-wP₂O₅-vMX;
xM₂S-ySiS₂;
MPSX (or example MₐP_{b}S_{c}X_{d} such as M₇P₂S₈X, and M₆PS₅X);
MPSOX (for example, MₐP_{b}S_{c}O_{d}Xₑ);
MGPSX (for example, MₐGe_{b}P_{c}S_{d}Xₑ);
MGPSOX (for example, MₐGe_{b}P_{c}S_{d}OₑX_{f});
MSiPSX (for example, MₐSi_{b}P_{c}S_{d}Xₑ);
MSiPSOX (for example, MₐSi_{b}P_{c}S_{d}OₑX_{f});
MSnPSX (for example, MₐSn_{b}P_{c}S_{d}Xₑ);
MSnPSOX (for example, MₐSn_{b}P_{c}S_{d}OₑX_{f});
MZPSX (for example, MₐZn_{b}P_{c}S_{d}Xₑ);
MZPSOX (for example, MₐZn_{b}P_{c}S_{d}OₑX_{f});
M₃OX;
M₂HOX;
M₃PO₄;
M₃PS₄; and
MₐPO_{b}N_{c}(where a=; 2b+3c−5);
wherein:
M is an alkali metal ion, an alkaline earth metal ion, or a combination thereof, and wherein when M comprises an alkaline earth metal ion, then the number of M is adjusted to achieve electroneutrality, preferably M is selected from Li, Na, K, Rb, Cs, Be, Mg, Ca, Sr, Ba, and a combination of at least two thereof, and more preferably M is Li;
X is selected from F, Cl, Br, I, or a combination of at least two thereof:
a, b, c, d, e, and f are numbers other than zero and are, independently in each formula,
selected to achieve electroneutrality; and
v, w, x, v, and z are numbers other than zero and are, independently in each formula, selected to obtain a stable compound;
(iv) the inorganic solid electrolyte material is selected from argyrodite-type inorganic compounds of formula Li₆PS₅X, wherein X is C, Br, I, or a combination of at least two thereof; or
(v) the Inorganic solid electrolyte material is Li₆PS₅Cl.

65-70. (canceled)

71. The electrochemical cell of claim 58, wherein
the negative electrode comprises an electrochemically active material comprising an alkali metal, an alkaline earth metal, an alloy comprising at least one alkali or alkaline earth metal, a non-alkali and non-alkaline earth metal, an alloy or an intermetallic compound, preferably the electrochemically active material of the negative electrode comprises metallic lithium or an alloy including metallic lithium, preferably wherein the electrochemically active material of the negative electrode is in the form of a film having a thickness in the range of from about 5 μm to about 500 μm, preferably in the range of from about 10 μm to about 100 μm upper and lower limits included, or
the positive electrode is pre-lithiated and the negative electrode is substantially free of lithium, and preferably the negative electrode is lithiated in situ during the cycling of said electrochemical cell.

72-76. (canceled)

77. An electrochemical accumulator comprising at least one electrochemical cell as defined in claim 58, said electrochemical accumulator is a battery selected from a lithium battery, a lithium-ion battery, a sodium battery, a sodium-ion battery, a magnesium battery, and a magnesium-ion battery, and preferably said battery is a lithium battery or a lithium-ion battery, and preferably wherein said electrochemical accumulator is an all-solid-state battery.

78-80. (canceled)
